(19) United States
(12) Patent Application Publication
(10) Pub. No.: US 2026/0081984 A1
(43) Pub. Date: Mar. 19, 2026

(54) ELECTRONIC DEVICE COMPRISING FLEXIBLE DISPLAY, AND OPERATING METHOD THEREOF

(71) Applicant: Samsung Electronics Co., Ltd., Suwon-si (KR)

(72) Inventors: Jaebum LEE, Suwon-si (KR); Junho LEE, Suwon-si (KR); Youngho KIM, Suwon-si (KR); Hyunju HONG, Suwon-si (KR); Seokmin JANG, Suwon-si (KR)

(21) Appl. No.: 19/400,192

(22) Filed: Nov. 25, 2025

Related U.S. Application Data
(63) Continuation of application No. PCT/KR2024/005967, filed on May 2, 2024.

(30) Foreign Application Priority Data
Jun. 20, 2023 (KR) 10-2023-0078879
Aug. 30, 2023 (KR) 10-2023-0114884

(51) Int. Cl. H04M 1/02; G09G 3/00; H04M 1/72403

(52) U.S. Cl. CPC H04M 1/0268; G09G 3/006; G09G 3/035; G09G 2340/0442; G09G 2354/00; H04M 1/72403

(57) ABSTRACT

An electronic device is provided. The electronic device includes a housing, a display including a fixed part which maintains a flat surface, and a rolling part which extends from the fixed part and of which one portion is bent in response to movement so as to be partially withdrawn out of the housing or inserted into the housing, a display driver integrated circuit (IC) configured to drive the display, memory, including one or more storage media, storing instructions, and at least one processor, configured to control the display driver IC, communicatively coupled to the display, the display driver IC, and the memory, wherein the display includes multiple detection wires connected to the display driver IC to distinguish and detect damage of the fixed part or the rolling part, and arranged on an edge of the display.

### CROSS-REFERENCE TO RELATED APPLICATION(S)

This application is a continuation application, claiming priority under 35 U.S.C. § 365(c), of an International application No. PCT/KR2024/005967, filed on May 2, 2024, which is based on and claims the benefit of a Korean patent application number 10-2023-0078879, filed on Jun. 20, 2023, in the Korean Intellectual Property Office, and of a Korean patent application number 10-2023-0114884, filed on Aug. 30, 2023, in the Korean Intellectual Property Office, the disclosure of each of which is incorporated by reference herein in its entirety.

### BACKGROUND

### 1. Field

The disclosure relates to an electronic device including a flexible display and an operating method thereof.

### 2. Description of Related Art

An electronic device may refer to a device that performs a designated function according to a loaded program, such as a smart-phone, a tablet personal computer (PC), a wearable electronic device, a smart-watch, a home appliance, an electronic notebook, a portable multimedia player, a mobile communication terminal, a tablet PC, an audio/video device, a desktop/laptop computer, a navigation system for vehicles, an augmented reality (AR) device, a virtual reality (VR) device, an Mixed reality (MR) device, or an extended reality (XR) device. Electronic devices have been developed to gradually become slimmer and have increased rigidity, strengthened design aspects, and differentiated functional elements. An electronic device is gradually changing from the uniform rectangular shape to more diverse shapes. The electronic device may have a changeable structure which may use a large screen display while securing convenient potability. An electronic device may include a rollable display (or flexible display) of which display area is variable (e.g., expanded or reduced) in response to a structural change in at least one housing. The electronic device may have a structure (e.g., a rollable structure or a slidable structure) that allows the display area of the flexible display to be varied (e.g., extended or reduced) through support of housings operating in a sliding manner with respect to each other.

The above information is presented as background information only to assist with an understanding of the disclosure. No determination has been made, and no assertion is made, as to whether any of the above might be applicable as prior art with regard to the disclosure.

### SUMMARY

An electronic device may include a rollable electronic device (e.g., a slidable electronic device) allowing a display area of a display to be extended and/or reduced. The rollable electronic device may include a first housing (e.g., a first housing structure, a movable structure, a slide housing, a slide bracket, or a slide structure) and a second housing (e.g., a second housing structure, a fixed structure, a base housing, a base bracket, or a base structure) that are movably coupled to each other in a manner in which the first housing and the second housing are at least partially fitted together. For example, the first housing and the second housing may be slidably operable relative to each other and may support at least a portion of a rollable display or a flexible display (e.g., an expandable display or a stretchable display). In a slide-in state of the electronic device, the rollable display (or the flexible display) may be induced to have a first display area. In a slide-out state of the electronic device, the rollable display (or the flexible display) may be induced to have a second display area greater than the first display area. The rollable display (or the flexible display) may include multiple layers including a display panel, which are stacked on an upper and/or lower surface through an adhesive member (e.g., a pressure sensitive adhesive (PSA)). For example, the multiple layers may include a window layer, a protection layer, or multiple functional layers. More particularly, in order to improve the durability of a bendable area received into an internal space of the electronic device in the slide-in state, the rollable display (e.g., the flexible display) may have at least one rigid reinforcing layer (e.g., a multi-bar or a support plate) added through the adhesive member.

When a rollable display (or the flexible display) is slid in or out, a first part (e.g., a fixed part) does not change the shape thereof, but a second part (e.g., a rolling part) may be repeatedly rolled and unrolled. Since the rollable display (or the flexible display) includes multiple layers, the rolling part may be vulnerable to cracks (e.g., damage) due to a difference in curvature between the layers when the display is slid in and out. When the display is slid in and out, since the second part (e.g., a rolling part) is repeatedly rolled and unrolled, cracks (e.g., damage) may occur in the rolling part.

Aspects of the disclosure are to address at least the above-mentioned problems and/or disadvantages and to provide at least the advantages described below. Accordingly, an aspect of the disclosure is to provide a rollable electronic device capable of controlling operation of a rollable display by detecting a crack (e.g., damage) in a rolling part of the rollable display and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a housing, a display including a fixed part which maintains a flat surface and a rolling part extending from the fixed part and having a portion bent according to movement so as to be partially slid out from the housing or slid into the housing, a display driver integrated circuit (IC) configured to drive the display, memory, including one or more storage media, storing instructions, and at least one processor, configured to control the display driver IC, communicatively coupled to the display, the display driver IC, and the memory, wherein the display includes multiple detection wires connected to the display driver IC in order to distinguish and detect damage of the fixed part or the rolling part, and arranged on an edge of the display.

In accordance with another aspect of the disclosure, a method of operating an electronic device is provided. The electronic device includes a housing, a display including a fixed part maintaining a flat surface and a rolling part extending from the fixed part and having a portion bent according to movement so as to be partially slid out from the housing or slid into the housing, a display driver integrated circuit (IC) configured to drive the display, memory, including one or more storage media, storing instructions, and at least one processor, configured to control the display driver IC, communicatively coupled to the display, the display driver IC, and the memory, wherein the display includes multiple detection wires connected to the display driver IC to distinguish and detect damage of the fixed part or the rolling part, and arranged on an edge of the display, wherein the method includes driving the display driver IC so that detection signals for detecting damage of the display are supplied to first sides of the respective multiple detection wires, receiving feedback signals for the detection signals input from second sides of the respective multiple detection wires through the display driver IC, and determining whether at least one of the fixed part or the rolling part is damaged, based on the feedback signals.

The rollable electronic device and the operating method thereof according to various embodiments of the disclosure detect a crack (e.g., damage) in each of a fixed part and a rolling part of the rollable display.

The rollable electronic device and the operating method thereof according to various embodiments of the disclosure segment the rolling part of the rollable display into multiple areas and detect a crack (e.g., damage) in each of the multiple areas of the rolling part of the rollable display.

The rollable electronic device and the operating method thereof according to various embodiments of the disclosure detect a crack (e.g., damage) in the rolling part of the rollable display and control the operation of the rollable display.

The rollable electronic device and the operating method thereof according to various embodiments of the disclosure maintain a screen ratio of a pushed-in (e.g., slide-in) state even in a pulled-out (e.g., slide-out) state when a crack (e.g., damage) occurs in the rolling part of the rollable display.

The rollable electronic device and the operating method thereof according to various embodiments of the disclosure detect a crack (e.g., damage) in the rolling part of the rollable display and control driving of a motor for pushing in and pulling out the rollable display.

The rollable electronic device and the operating method thereof according to various embodiments of the disclosure display a notification message (or provide a voice comment on the occurrence of a crack (or damage) in the rolling part of the rollable display) when a crack occurs (e.g., damage).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block view illustrating an electronic device in a network environment according to an embodiment of the disclosure;

FIGS. 2A and 2B are views illustrating a front surface and a rear surface of an electronic device in a first state (e.g., a slide-out state) according to various embodiments of the disclosure;

FIGS. 3A and 3B are views illustrating a front surface and a rear surface of an electronic device in a second state (e.g., a slide-in state) according to various embodiments of the disclosure;

FIG. 4 is a block view illustrating a configuration of an electronic device according to an embodiment of the disclosure;

FIGS. 5A and 5B are views illustrating a front surface and a rear surface of an electronic device in a first state (e.g., a slide-out state) according to various embodiments of the disclosure;

FIGS. 6A and 6B are views illustrating a front surface and a rear surface of an electronic device in a second state (e.g., a slide-in state) according to various embodiments of the disclosure;

FIG. 7A is a view illustrating an electronic device according to an embodiment of the disclosure;

FIG. 7B is a view illustrating that a display driver integrated circuit (DDIC) and multiple detection wires (e.g., conductive wires, metal wires, module crack detection (MCD) wires, circuit wires, or circuit patterns) are connected to each other according to an embodiment of the disclosure;

FIG. 8 is a view illustrating multiple detection wires (e.g., conductive wires, metal wires, module crack detection (MCD) wires, circuit wires, and circuit patterns) arranged on a second part (e.g., a non-display part or bezel area) of a rollable display according to an embodiment of the disclosure;

FIG. 9 is a view illustrating a method for determining a crack (e.g., damage) in a rollable display in an electronic device according to an embodiment of the disclosure;

FIG. 10 is a flowchart illustrating an operating method of a rollable electronic device according to an embodiment of the disclosure;

FIGS. 11A, 11B, and 11C are views illustrating a method for notifying occurrence of a crack (e.g., damage) in a rollable display and controlling a screen operation of the rollable display when a crack (e.g., damage) occurs in the rollable display according to various embodiments of the disclosure;

FIG. 12 is a flowchart illustrating a method for notifying occurrence of a crack (e.g., damage) in a rollable display and controlling a screen operation of the rollable display when a crack (e.g., damage) occurs in a rolling part of the rollable display according to an embodiment of the disclosure;

FIG. 13 is a view illustrating an electronic device according to an embodiment of the disclosure;

FIG. 14 is a view illustrating an electronic device according to an embodiment of the disclosure;

FIG. 15 is a view illustrating dividing a rolling part into multiple areas and operating the rolling part when a crack (e.g., damage) occurs in the rolling part of a rollable display according to an embodiment of the disclosure; and

FIG. 16 is a flowchart illustrating a method for dividing a rolling part into multiple areas and operating the rolling part when a crack (e.g., damage) occurs in the rolling part of a rollable display according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

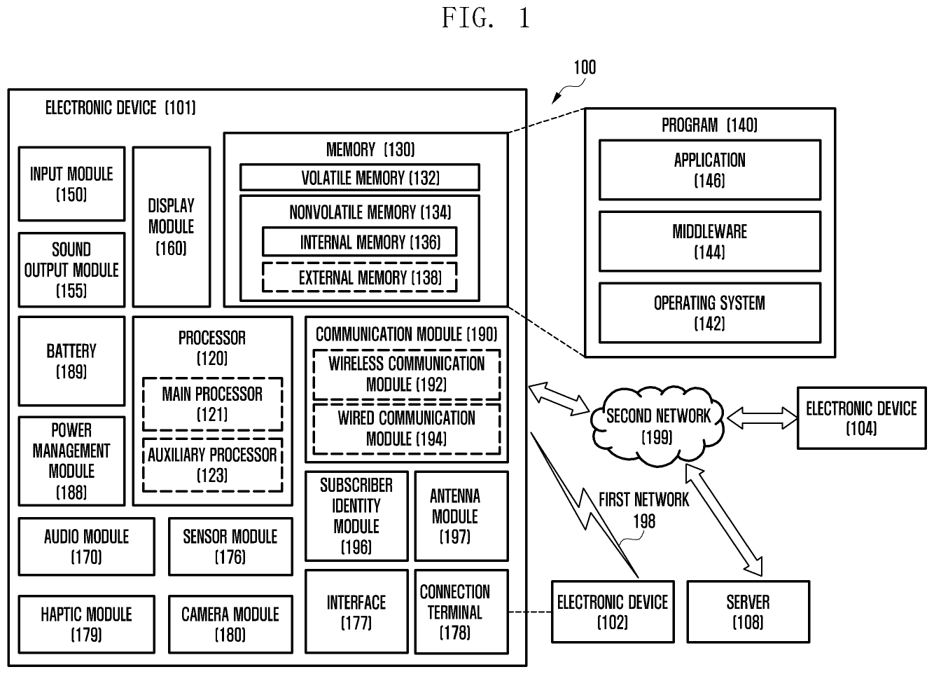

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IOT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

According to an embodiment of the disclosure, the display module 160 may include a flexible display disposed to be foldable or unfoldable to provide a screen (e.g., a display screen).

According to an embodiment of the disclosure, the display module 160 may include a rollable display disposed to be rolled or unrolled to provide a screen (e.g., a display screen) of which display area is variable (e.g., expanded or reduced).

According to an embodiment of the disclosure, the display module 160 may be also referred to as a variable display (e.g., a stretchable display), an expandable display, or a slide-in/out display.

According to an embodiment of the disclosure, the display module 160 may include a bar type or plate type display.

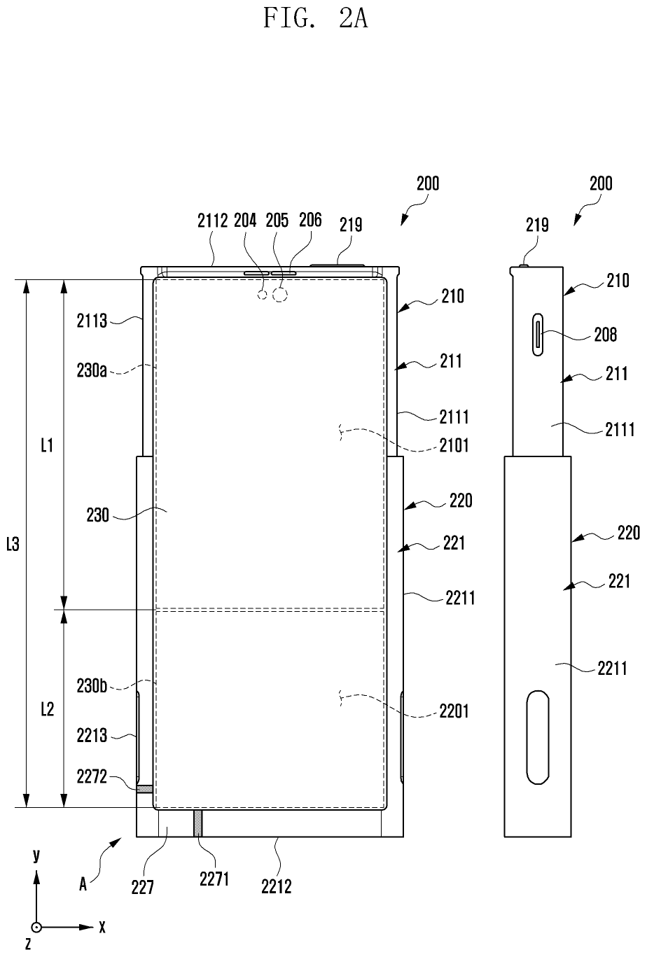

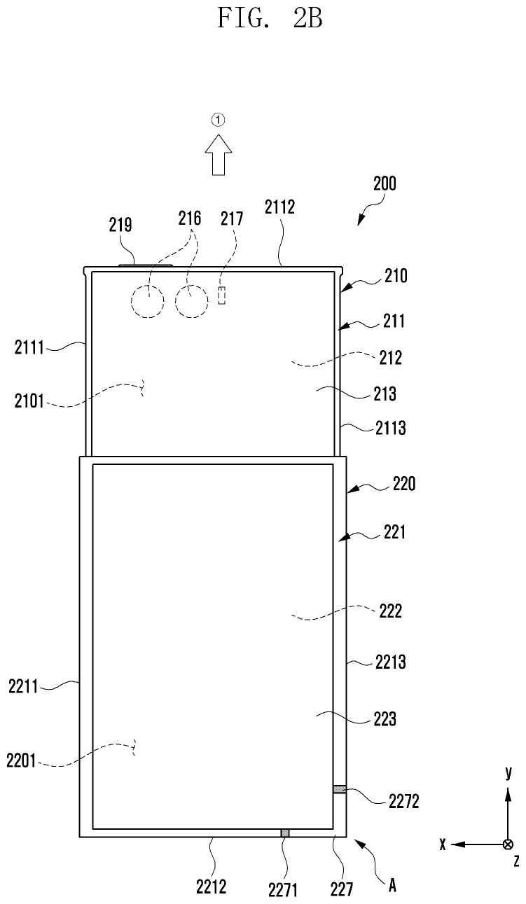

FIGS. 2A and 2B are views illustrating a front surface and a rear surface of an electronic device in a first state (e.g., a slide-out state) according to various embodiments of the disclosure.

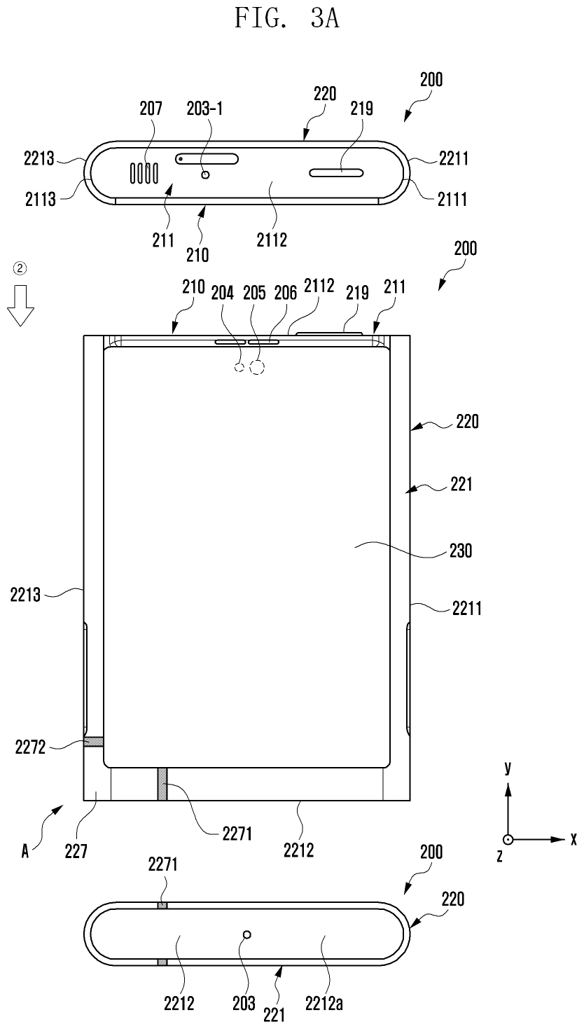

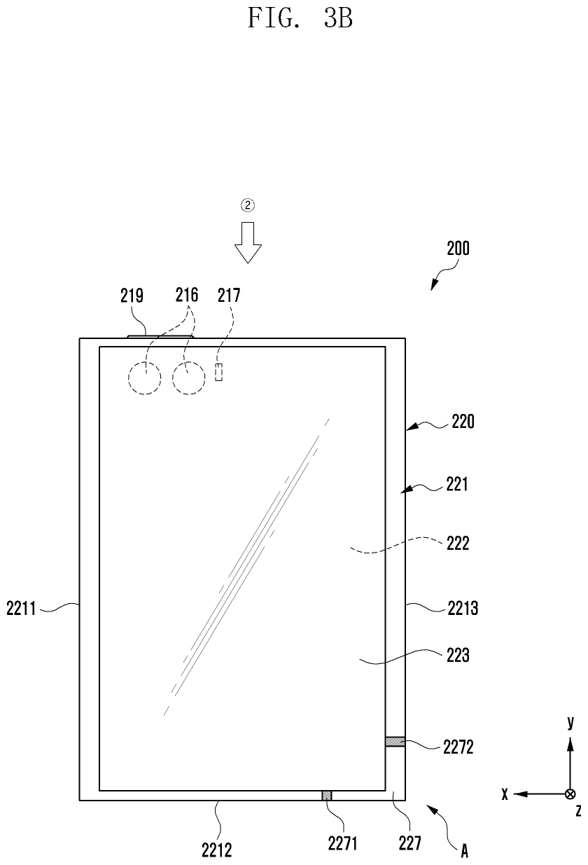

FIGS. 3A and 3B are views illustrating a front surface and a rear surface of an electronic device in a second state (e.g., a slide-in state) according to various embodiments of the disclosure.

The electronic device 200 In FIGS. 2A, 2B, 3A, and 3B may be at least partially similar to the electronic device 101 in FIG. 1 or may further include other embodiments of the electronic device 101.

Referring to FIGS. 2A, 2B, 3A, and 3B, the electronic device 200 according to an embodiment of the disclosure may vary (e.g., extend or reduce) a display area of a rollable display 230 (e.g., a flexible display) by sliding two housings 210 and 220 with respect to each other in a designated direction (e.g., direction \textcircled{1} or direction \textcircled{2}) (e.g., ±y-axis direction). However, the disclosure is not limited thereto, and the electronic device 200 may also be configured to induce variation (e.g., expansion or reduction) of the display area of the rollable display 230 by sliding two housings 210 and 220 in a direction (e.g., ±x-axis direction) perpendicular to the designated direction.

According to an embodiment of the disclosure, the electronic device 200 may include a first housing 210 (e.g., a first housing structure, a moving part, or a sliding housing), a second housing 220 (e.g., a second housing structure, a fixed part, or a base housing) coupled to the first housing 210 to be slidable in a designated direction (e.g., direction \textcircled{1} or direction \textcircled{2}) (e.g., the ±y-axis direction), and a rollable display 230 (e.g., a flexible display) (e.g., an expandable display or a stretchable display) disposed to be supported by at least a portion of the first housing 210 and the second housing 220.

According to an embodiment of the disclosure, the electronic device 200 may be configured to have the first housing 210 disposed to be slid out in a first direction (direction \textcircled{1}) (e.g., the y-axis direction) or to be slid in in a second direction (direction \textcircled{2}) (e.g., the ±y-axis direction) opposite to the first direction (direction \textcircled{1}) based on the second housing 220 gripped by the user.

According to an embodiment of the disclosure, at least a portion of the first housing 210 including a first space 2101 may be received in a second space 2201 of the second housing 220 so as to be converted into the slide-in state. For example, the state may be changed from the first state (e.g., the slide-out state) to the second state (e.g., the slide-in state).

According to an embodiment of the disclosure, the electronic device 200 may include a bendable member (or bendable support member) (e.g., a multi-joint hinge module or a multi-bar assembly) to define at least partially the same plane with at least a portion of the first housing 210 in the slide-out state.

According to an embodiment of the disclosure, in the slide-in state of the electronic device 200, the bendable member (or bendable support member) (e.g., a multi-joint hinge module or a multi-bar assembly) may be at least partially received in the second space 2201 of the second housing 220.

According to an embodiment of the disclosure, in the slide-in state, at least a portion of the rollable display 230 may be received in the second space 2201 of the second housing 220 while being supported by the bendable member so as to be disposed to be invisible from the outside.

According to an embodiment of the disclosure, in the slide-out state, at least a portion of the rollable display 230 may be disposed to be visible from the outside while being supported by the bendable member configured to at least partially configure the same plane with first housing 210.

According to various embodiments of the disclosure, the electronic device 200 may include the first housing 210 including a first lateral member 211 and the second housing 220 including a second lateral member 221.

According to an embodiment of the disclosure, the first lateral member 211 may include a first lateral surface 2111 having a first length along a first direction (e.g., the y-axis direction), a second lateral surface 2112 extending to have a second length longer than the first length along a direction (e.g., the x-axis direction) substantially perpendicular to the first lateral surface 2111, and a third lateral surface 2113 extending from the second lateral surface 2112 to be substantially perpendicular to the first lateral surface 2111 and having the first length.

According to an embodiment of the disclosure, the first lateral member 211 may be at least partially made of a conductive member (e.g., a metal). For example, the first lateral member 211 may be made of a combination of a conductive member and a non-conductive member (e.g., polymer).

According to an embodiment of the disclosure, the first housing 210 may include a first support member 212 extending from at least a portion of the first lateral member 211 to at least a portion of the first space 2101.

According to an embodiment of the disclosure, the first support member 212 may be integrally formed with the first lateral member 211. For example, the first support member 212 may be configured separately from the first lateral member 211 and structurally coupled to the first lateral member 211.

According to various embodiments of the disclosure, the second lateral member 221 may at least partially correspond to the first lateral surface 2111. The second lateral member 221 may include a fourth lateral surface 2211 having a third length, a fifth lateral surface 2212 extending from the fourth lateral surface 2211 in a direction substantially parallel to the second lateral surface 2112 and having a fourth length shorter than the third length, and a sixth lateral surface 2213 extending from the fifth lateral surface 2212 to correspond to the third lateral surface 2113 and having the third length.

According to an embodiment of the disclosure, the second lateral member 221 may be at least partially made of a conductive member (e.g., a metal). For example, the second lateral member 221 may be made of a combination of a conductive member and a non-conductive member (e.g., polymer).

According to an embodiment of the disclosure, at least a portion of the second lateral member 221 may include a second support member 222 extending to at least a portion of the second space 2201 of the second housing 220.

According to an embodiment of the disclosure, the second support member 222 may be integrally formed with the second lateral member 221. For example, the second support member 222 may be configured separately from the second lateral member 221 and structurally coupled to the second lateral member 221.

According to various embodiments of the disclosure, the first lateral surface 2111 and the fourth lateral surface 2211 may be slidably coupled to each other.

According to an embodiment of the disclosure, the third lateral surface 2113 and the sixth lateral surface 2213 may be slidably coupled to each other.

According to an embodiment of the disclosure, in the slide-in state, the first lateral surface 2111 may be disposed to be substantially invisible from the outside by overlapping the fourth lateral surface 2211.

According to an embodiment of the disclosure, in the slide-in state, the third lateral surface 2113 may be disposed to be substantially invisible from the outside by overlapping the sixth lateral surface 2213. For example, at least a portion of the first lateral surface 2111 and the third lateral surface 2113 may be disposed to be at least partially visible from the outside in the slide-in state.

According to an embodiment of the disclosure, in the slide-in state, the first support member 212 may be disposed to be substantially invisible from the outside by overlapping the second support member 222.

According to various embodiments of the disclosure, the first housing 210 may include a first rear cover 213 coupled to at least a portion of the first lateral member 211.

According to an embodiment of the disclosure, the first rear cover 213 may be disposed in a manner of being coupled to at least a portion of the first support member 212. For example, the first rear cover 213 may be integrally formed with the first lateral member 211.

According to an embodiment of the disclosure, the first rear cover 213 may be made of polymer, coated or colored glass, ceramic, or a metal (e.g., aluminum, stainless steel (STS), or magnesium), or a combination of at least two thereof. For example, the first rear cover 213 may extend to at least a portion of the first lateral member 211. For example, at least a portion of the first support member 212 may be replaced by the first rear cover 213.

According to various embodiments of the disclosure, the second housing 220 may include a second rear cover 223 coupled to at least a portion of the second lateral member 221.

According to an embodiment of the disclosure, the second rear cover 223 may be disposed in a manner of being coupled to at least a portion of the second support member 222. For example, the second rear cover 223 may be integrally formed with the second lateral member 221.

According to an embodiment of the disclosure, the second rear cover 223 may be made of polymer, coated or colored glass, ceramic, or a metal (e.g., aluminum, stainless steel (STS), or magnesium), or a combination of at least two thereof. For example, the second rear cover 223 may extend to at least a portion of the second lateral member 221. For example, at least a portion of the second support member 222 may be replaced by the second rear cover 223.

According to various embodiments of the disclosure, the rollable display 230 may be disposed to be supported by at least a portion of the first housing 210 and the second housing 220.

According to an embodiment of the disclosure, the rollable display 230 may include a first part 230a (e.g., a flat part) always visible from the outside and a second part 230b (e.g., a bendable part) extending from the first part 230a. The second part 230b (e.g., the bendable part) may be at least partially received in the second space 2201 of the second housing 220 so as not to be visible from the outside in the slide-in state.

According to an embodiment of the disclosure, the first part 230a may be disposed to be supported by the first housing 210. The second part 230b may be disposed to be supported at least partially by the bendable member.

According to an embodiment of the disclosure, the second part 230b of the rollable display 230 may be extended from the first part 230a while receiving support from the bendable member in a state where the first housing 210 is slid out along the first direction (direction \textcircled{1}). The second part 230b of the rollable display 230 may be disposed to define substantially the same plane with the first part 230a and be visible from the outside in a state where the first housing 210 is slid out along the first direction (direction \textcircled{1}).

According to an embodiment of the disclosure, the second part 230b of the rollable display 230 may be received in the second space 2201 of the second housing 220 in a state where the first housing 210 is slid in along the second direction (direction 2). According to an embodiment of the disclosure, the second part 230b of the rollable display 230 may be disposed so as not to be visible from the outside in a state where the first housing 210 is slid in along the second direction (direction \textcircled{2}). Accordingly, the electronic device 200 may have a display area of the rollable display 230 to be variable (e.g., extended or reduced) according to the first housing 210 moving from the second housing 220 along a designated direction (e.g., the ±y-axis direction) in a sliding manner.

According to various embodiments of the disclosure, the rollable display 230 may have a length variable (e.g., extended or reduced) in the first direction (direction \textcircled{1}) according to a sliding movement of the first housing 210 moved based on the second housing 220. For example, the rollable display 230 may have a first display area (e.g., an area corresponding to the first part 230a) corresponding to a first length L1 in the slide-in state.

According to an embodiment of the disclosure, the rollable display 230 may slide the first housing 210 by a second length L2 relative to the second housing 220 in the slide-out state. The rollable display 230 may correspond to a third length L3 greater than the first length L1 in the slide-out state. The rollable display 230 may be extended to have a third display area (e.g., an area including the first part 230a and the second part 230b) greater than the first display area in the slide-out state.

According to an embodiment of the disclosure, in the first state (e.g., the slide-out state) of the electronic device 200, a screen size (e.g., a screen area) of the rollable display 230 visible to the outside may be maximized (e.g., substantially maximum).

According to an embodiment of the disclosure, in the second state (e.g., the slide-in state) of the electronic device 200, a screen size (e.g., a screen area) of the rollable display 230 visible to the outside may be minimized (e.g., substantially minimum).

According to an embodiment of the disclosure, in a third state (e.g., an intermediate state) of the electronic device 200, a screen size (e.g., a screen area) of the rollable display 230 visible to the outside may be smaller than that of the first state (e.g., the slide-out state) and larger than that of the second state (e.g., the slide-in state). For example, in the third state (e.g., the intermediate state) of the electronic device 200, a screen size (e.g., a screen area) of the rollable display 230 visible to the outside may be smaller than the maximum size (e.g., the maximum screen area) and larger than the minimum size (e.g., the minimum screen area).

According to various embodiments of the disclosure, the electronic device 200 may include at least one of an audio input device (e.g., a microphone 203-1), an audio output device (e.g., a call receiver 206 or a speaker 207), a sensor module 204 or 217, a camera module (e.g., a first camera module 205 or a second camera module 216), a connector port 208, a key input device 219, or an indicator (not shown) each of which is disposed in the first space 2101 of the first housing 210.

According to an embodiment of the disclosure, the electronic device 200 may include another input device (e.g., a microphone 203) disposed in the second housing 220. For another embodiment of the disclosure, the electronic device 200 may be configured to omit at least one of the above-described components or additionally include other components. For another embodiment of the disclosure, at least one of the aforementioned components may be disposed in the second space 2201 of the second housing 220.

According to another embodiment of the disclosure, the audio input device may include the microphone 203-1. In an embodiment of the disclosure, the audio input device (e.g., the microphone 203-1) may include multiple microphones arranged so as to detect a direction of a sound. The sound output device may include, for example, the call receiver 206 and the speaker 207.

According to an embodiment of the disclosure, the speaker 207 may correspond to the outside through at least one speaker hole disposed in the first housing 210 at a position (e.g., the second lateral surface 2112) always exposed to the outside regardless of the slide-in/slide-out state.

According to an embodiment of the disclosure, the connector port 208 (e.g., a universal serial bus (USB) type C terminal) may correspond to the outside through at least one connector hole port provided in the first housing 210 in the slide-out state. For example, the connector port 208 may correspond to the outside through an opening disposed through the second housing and corresponding to the connector port hole in the slide-in state. For example, the call receiver 206 may include a speaker (e.g., a piezo speaker) operating without a separate speaker hole.

According to various embodiments of the disclosure, the sensor module 204 or 217 may generate an electrical signal or a data value corresponding to an internal operation state or external environment state of the electronic device 200. For example, the sensor module 204 or 217 may include a first sensor module 204 (e.g., a proximity sensor or an illuminance sensor) disposed on the front surface of the electronic device 200 and/or a second sensor module 217 (e.g., a heart rate monitoring (HRM) sensor) disposed on the rear surface of the electronic device 200.

According to an embodiment of the disclosure, the first sensor module 204 may be disposed under (e.g., a lower part based on the z-axis direction) the rollable display 230 on the front surface of the electronic device 200.

According to an embodiment of the disclosure, the first sensor module 204 and/or the second sensor module 217 may include at least one of a proximity sensor, an illumination sensor, a time of flight (TOF) sensor, an ultrasonic sensor, a fingerprint recognition sensor, a gesture sensor, a gyro sensor, an air pressure sensor, a magnetic sensor, an acceleration sensor, a grip sensor, a color sensor, an infrared (IR) sensor, a biometric sensor, a temperature sensor, or a humidity sensor.

According to various embodiments of the disclosure, the camera module may include a first camera module 205 disposed on the front surface of the electronic device 200 and a second camera module 216 disposed on the rear surface of the electronic device 200.

According to an embodiment of the disclosure, the electronic device 200 may include a flash (not shown) located adjacent to the second camera module 216.

According to an embodiment of the disclosure, the camera modules 205 or 216 may include one or more of lenses, an image sensor, and/or an image signal processor.

According to an embodiment of the disclosure, the first camera module 205 may be disposed under (e.g., a lower part based on the z-axis direction) the rollable display 230. The first camera module 205 may be disposed under (e.g., a lower part based on the z-axis direction) the rollable display 230 and configured to photograph a subject through a partial portion of an activation area (e.g., a display area) of the rollable display 230.

According to various embodiments of the disclosure, the first camera module 205 among the camera modules may be disposed to detect an external environment through the rollable display 230. A specific sensor module 204 among the sensor modules 204 and 217 may be disposed to detect an external environment through the rollable display 230. For example, the first camera module 205 or the specific sensor module 204 may be disposed in the first space 2201 of the first housing 210 to be in contact with the external environment through a transmission area or a perforated opening formed on the rollable display 230.

According to an embodiment of the disclosure, an area facing the first camera module 205 of the rollable display 230 may correspond to a portion of the display area configured to display contents, and may be formed to be a transmission area having predetermined transmittance.

According to an embodiment of the disclosure, the transmission area of the rollable display 230 may be configured to have transmittance in the range of about 5% to about 20%. Such transmission area may include an area overlapping an effective area (e.g., a view-angle region) of the first camera module 205 through which light for imaging to an image sensor to generate an image passes. For example, the transmission area of the rollable display 230 may include an area having a lower pixel arrangement density and/or wire density than a peripheral area. For example, the transmission area may be substituted with the aforementioned opening. For example, a specific camera module 205 may include an under display camera (UDC). For example, a specific sensor module 204 may be disposed in the internal space of the electronic device 200 to perform functions thereof without being visually exposed through the rollable display 230.

According to various embodiments of the disclosure, the electronic device 200 may include a bezel antenna A disposed through the conductive second lateral member 221 of the second housing 210. For example, the bezel antenna A may be disposed on at least a portion of the fifth lateral surface 2212 and the sixth lateral surface 2213 of the second lateral member 221 and may include a conductive part 227 that is electrically segmented through at least one segment part 2271 or 2272 formed of a non-conductive material (e.g., polymer).

According to an embodiment of the disclosure, a wireless communication circuit (e.g., the wireless communication module 192 in FIG. 1) may be configured to transmit or receive a wireless signal in at least one frequency band (e.g., about 600 MHz to 9000 MHz) (e.g., a legacy band or NR band) designated through the conductive part 227.

According to an embodiment of the disclosure, the electronic device 200 may include a lateral cover 2212a disposed on the fifth lateral surface 2212 to cover at least a portion of the at least one segment part 2271. For example, the bezel antenna A may be disposed on at least one of the fourth lateral surface 2211, the fifth lateral surface 2212, and the sixth lateral surface 2213. For example, the bezel antenna A may be disposed on at least one of the first lateral surface 2111, the second lateral surface 2112, and the third lateral surface 2113 of the first housing 210.

According to an embodiment of the disclosure, the electronic device 200 may further include at least one antenna module (e.g., a 5G antenna module or antenna structure). For example, the at least one antenna module (e.g., a 5G antenna module or antenna structure) may be disposed in the internal space (e.g., the first space 2101 or the second space 2201) of the electronic device 200. The at least one antenna module (e.g., a 5G antenna module or antenna structure) may be disposed to transmit or receive a wireless signal in a frequency band ranging from about 3 GHz to 100 GHz through another wireless communication circuit (e.g., the wireless communication module 192 in FIG. 1).

According to various embodiments of the disclosure, a slide-in/slide-out operation of the electronic device 200 may be automatically preformed. For example, the slide-in/slide-out operation of the electronic device 200 may be performed through a combination of a drive motor (e.g., a gear drive unit) including a pinion gear and a rack gear. The rack gear may be disposed in the first space 2101 of the first housing 210. The drive motor (e.g., gear drive unit) including a pinion gear may be disposed in the second space 2201 of the second housing 220.

For example, in case of detecting a triggering operation for switching from the slide-in state to the slide-out state, the processor (e.g., the processor 120 in FIG. 1) of the electronic device 200 may operate the drive motor disposed inside the electronic device 200.

For example, in case of detecting a triggering operation for switching from the slide-out state to the slide-in state, the processor (e.g., the processor 120 in FIG. 1) of the electronic device 200 may operate the drive motor disposed inside the electronic device 200.

For example, the triggering operation for a state change (e.g., a change in the slide-in or slide-out state) of the electronic device 200 may include an operation of selecting (e.g., touching) an object displayed on the rollable display 230 or manipulating a physical button (e.g., a key button) included in the electronic device 200.

According to various embodiments of the disclosure, the electronic device 200 may have a drive motor disposed at an end part in a direction (direction \textcircled{1}) of sliding-out closest to the first space 2101 of the first housing 210 in the second space 2201 of the second housing 220. The electronic device 200 may have an electrical connection structure that is electrically connected to a first substrate (e.g., a main substrate) disposed in the first space 2101 through an electrical connection member. As such, the electrical connection structure between the first substrate 251 (e.g., a main substrate) and the drive motor 260 which are disposed in different housings 210 and 220, respectively, may be minimized, thereby helping to improve the operational reliability of the electronic device 200.

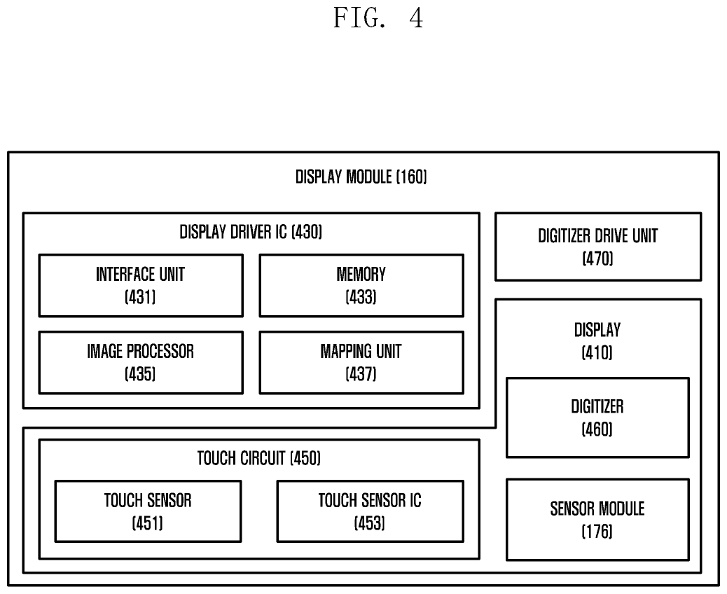

FIG. 4 is a block view illustrating a configuration of an electronic device according to an embodiment of the disclosure.

Referring to FIG. 4, a display module 160 (e.g., the display module 160 in FIG. 1) may include a display 410, a display driver IC (DDIC) 430 (e.g., a display drive unit) configured to drive the display 410, a touch circuit 450, a digitizer 460, a sensor module 176, and/or a digitizer drive unit 470.

According to an embodiment of the disclosure, the DDIC 430 may include an interface unit 431 (e.g., an interface module or an interface circuit), memory 433 (e.g., buffer memory), an image processor 435 (e.g., an image processing module or an image processing circuit), or a mapping unit 437 (e.g., a mapping module or a mapping circuit).

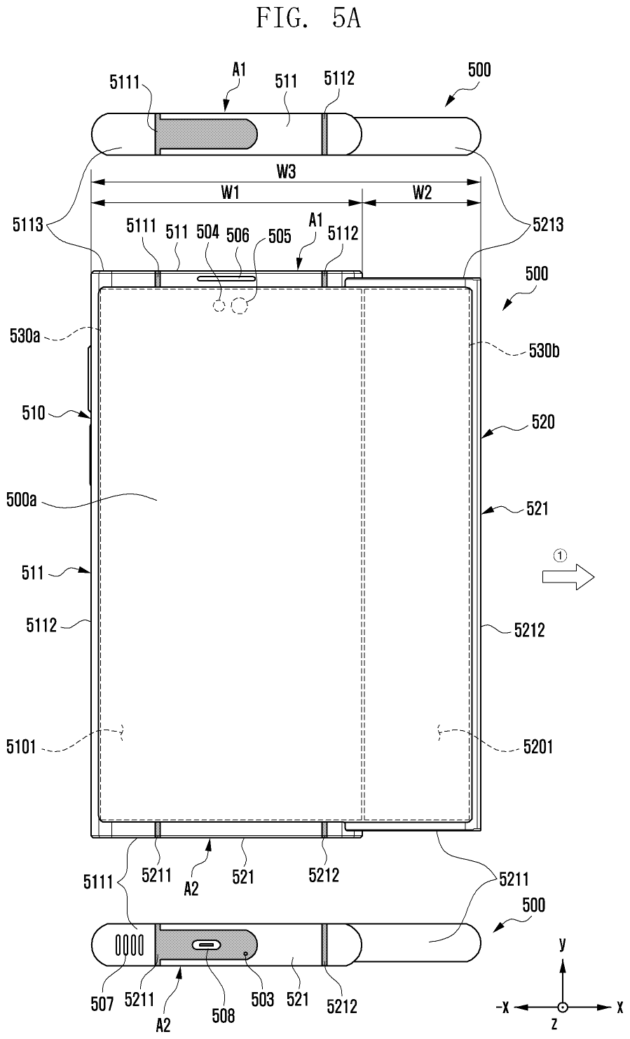

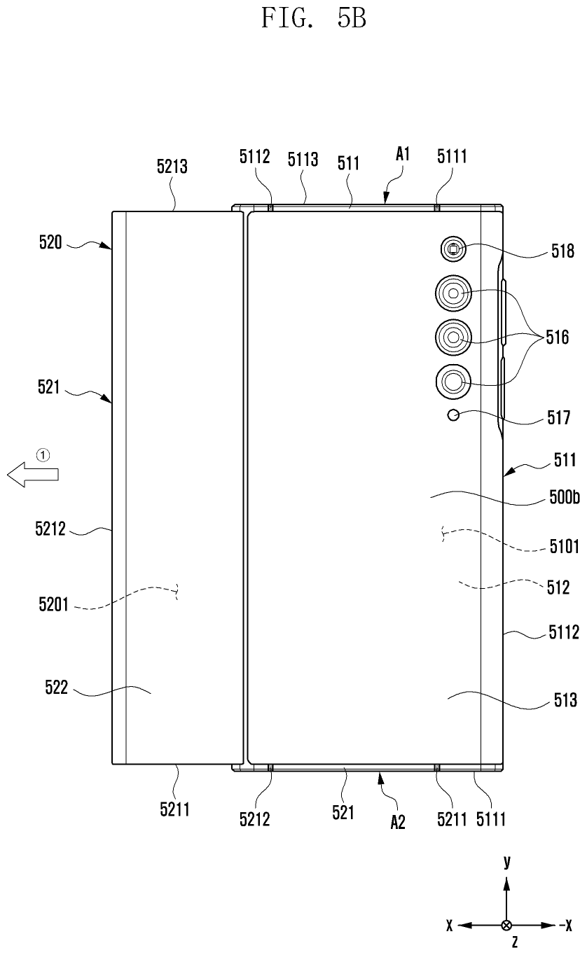

According to an embodiment of the disclosure, the DDIC 430 may receive image information including image data or an image control signal corresponding to an instruction for controlling the image data from another component of an electronic device (e.g., the electronic device 101 in FIG. 1, the electronic device 200 in FIG. 2A, or the electronic device 500 in FIG. 5A) through the interface unit 431.

According to an embodiment of the disclosure, the image information may be received from a processor (e.g., the processor 120 in FIG. 1) (e.g., the main processor 121 in FIG. 1) (e.g., an application processor) or an auxiliary processor (e.g., the auxiliary processor 123 in FIG. 1) (e.g., a graphic processing device) operating independently from a function of the main processor 121.

According to an embodiment of the disclosure, the DDIC 430 may communicate with the touch circuit 450 or the sensor module 176 through the interface unit 431 (e.g., an interface module or an interface circuit). In addition, the DDIC 430 may store at least a portion of the received image information in the memory 433. By way of example, the DDIC 430 may store at least a portion of the received image information in the memory 433 in a unit of frames.

According to an embodiment of the disclosure, the image processor 435 (e.g., an image processing module or an image processing circuit) may perform preprocessing or postprocessing (e.g., resolution, brightness, or size adjustment) on at least a portion of the image data. For example, the preprocessing or postprocessing of the image data may be performed at least based on a feature of the image data or a feature of the display 410.

According to an embodiment of the disclosure, the mapping unit 437 (e.g., a mapping module or a mapping circuit) may generate a voltage value or a current value corresponding to the image data preprocessed or postprocessed through the image processor 435. According to an embodiment of the disclosure, the generation of the voltage value or current value may be performed at least partially based on attributes (e.g., an arrangement (RGB stripe or pentile structure) of pixels or a size of each sub-pixel) of pixels of the display 410.

According to an embodiment of the disclosure, at least some pixels of the display 410 may be driven based on voltage values or current values. Through this, visual information (e.g., text, images, or icons) corresponding to the image data may be displayed through the display 410.

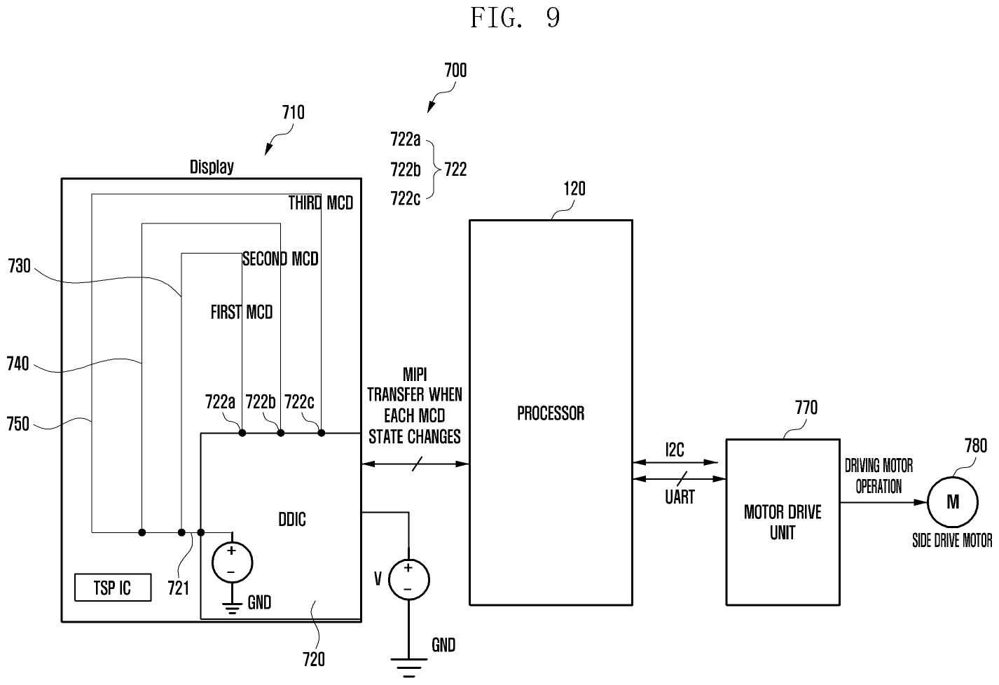

According to an embodiment of the disclosure, the touch circuit 450 may include a touch sensor 451 and a touch sensor IC 453 (e.g., a touch screen panel IC (TSP IC) in FIG. 9) configured to control the touch sensor 451.

According to an embodiment of the disclosure, the touch sensor IC 453 may control the touch sensor 451 to detect a touch input or a hovering input in a predetermined position of the display 410. For example, the touch sensor IC 453 may measure a change in a signal (e.g., a voltage, a light amount, resistance, or a voltage amount) for a predetermined position of the display 410 to detect a touch input or a hovering input. The touch sensor IC 453 may provide information on the detected touch input or hovering input (e.g., a position, an area, a pressure, or a time) to the processor (e.g., the processor 120 in FIG. 1).

According to an embodiment of the disclosure, at least a portion (e.g., the touch sensor IC 453) of the touch circuit 450 may be included as a portion of the DDIC 430 or the display 410.

According to an embodiment of the disclosure, at least a portion (e.g., the touch sensor IC 453) of the touch circuit 450 may be included as a portion of other components (e.g., the auxiliary processor 123) disposed outside the display module 160.

According to an embodiment of the disclosure, the display module 160 may further include at least one sensor (e.g., a fingerprint sensor, a pressure sensor, or an illuminance sensor) of the sensor module 176 or a control circuit therefor. In this case, the at least one sensor or the control circuit therefor may be embedded in a portion (e.g., the display 410 or the DDIC 430) of the display module 160 or a portion of the touch circuit 450.

For example, when the embedded sensor module 176 of the display module 160 includes a biosensor (e.g., a fingerprint sensor), the biosensor may obtain bio-information (e.g., a fingerprint image) related to a touch input through a partial area of the display 410.

For example, when the embedded sensor module 176 of the display module 160 includes a pressure sensor, the pressure sensor may obtain pressure information related to a touch input through a partial area or the whole area of the display 410.

According to an embodiment of the disclosure, the touch sensor 451 or the sensor module 176 may be disposed between pixels of a pixel layer of the display 410.

According to an embodiment of the disclosure, the touch sensor 451 or the sensor module 176 may be disposed on (or under) the pixel layer.

According to an embodiment of the disclosure, the display module 160 may include a digitizer 460 configured to detect an input (e.g., a touch input or hovering input) of an electronic pen (e.g., a stylus pen). For example, the digitizer 460 may convert analog coordinates (e.g., a position) of the electronic pen (e.g., a stylus pen) into digital coordinate data. The digitizer 460 may transmit the digital coordinate data to a processor (e.g., the processor 120 in FIG. 1) and/or the DDIC 430.

According to an embodiment of the disclosure, the processor (e.g., processor 120 in FIG. 1) may obtain digital coordinate data input from the digitizer 460. The processor 120 may detect an input (e.g., a touch input or hovering input) through an electronic pen (e.g., stylus pen) based on the digital coordinate data. For example, the digitizer 460 may include multiple x-axis channels and multiple y-axis channels. The processor 120 may detect a position of the electronic pen (e.g., a stylus pen) by using sensing signals (e.g., electro magnetic resonance (EMR) signals) received from the x-axis channels and the y-axis channels arranged in the digitizer 460. For example, the digitizer 460 may have the multiple x-axis channels and the multiple y-axis channels sequentially arranged therein, and the processor 120 may detect the position of the electronic pen (e.g., a stylus pen) by using sensing signals (e.g., EMR signals) received from the consecutive channels (e.g., three to five adjacent channels).

According to an embodiment of the disclosure, the digitizer 460 may not be visible from the outside due to the display 410, electronic components, and mechanisms.

For example, the digitizer 460 may be disposed integrally with the flat display 410 or may be disposed adjacent to the flat display 410. For example, in case that the digitizer 460 is applied to the flat display 410, the digitizer 460 may include one electro magnetic resonance (EMR) sheet (or EMR film). Multiple x-axis channels and multiple y-axis channels for detecting the position of the electronic pen may be disposed on one EMR sheet.

For example, the digitizer 460 may be disposed integrally with a flexible display or a foldable display or may be disposed adjacent to the flexible display or the foldable display. For example, the digitizer 460 may be disposed at a lower portion (e.g., below) of the display 410 in the z-axis direction (e.g., the z-axis direction in FIGS. 2A and 3A).

For example, in case that the digitizer 460 is applied to the rollable display, the digitizer 460 may include one electro magnetic resonance (EMR) sheet or multiple EMR sheets. Multiple x-axis channels and multiple y-axis channels for detecting the position of the electronic pen may be arranged on one EMR sheet (or EMR film) or multiple EMR sheets (or EMR films).

For example, in case that the digitizer 460 is applied to the flexible display or the foldable display, the digitizer 460 may include multiple EMR sheets (or EMR films). Multiple x-axis channels and multiple y-axis channels for detecting the position of the electronic pen may be disposed on the multiple EMR sheets.

FIGS. 5A and 5B are views illustrating a front surface and a rear surface of an electronic device in a first state (e.g., a slide-out state) according to various embodiments of the disclosure.

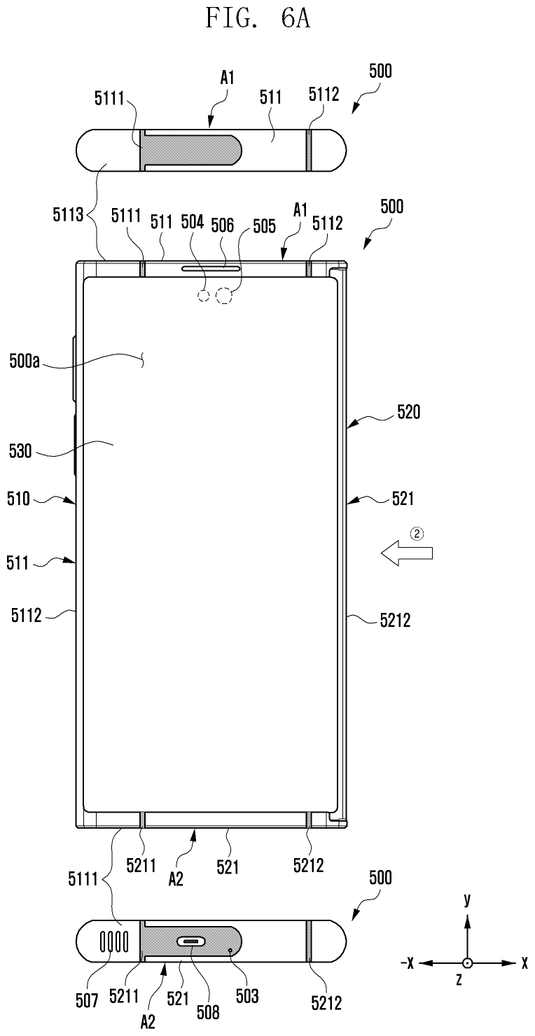

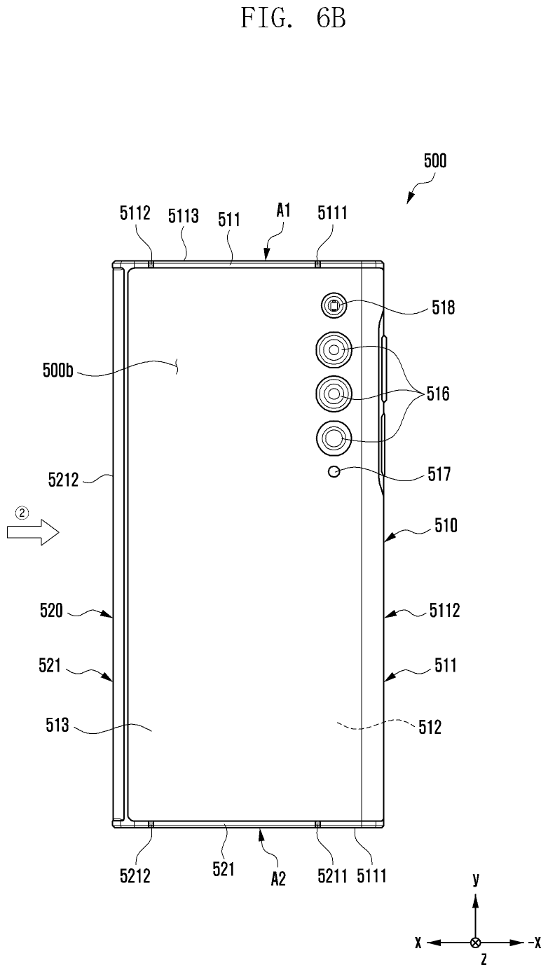

FIGS. 6A and 6B are views illustrating a front surface and a rear surface of an electronic device in a second state (e.g., a slide-in state) according to various embodiments of the disclosure.

The electronic device 500 in FIGS. 5A, 5B, 6A, and 6B may be at least partially similar to the electronic device 101 in FIG. 1 or may further include other embodiments of the electronic device.

Referring to FIGS. 5A, 5B, 6A, and 6B, the electronic device 500 according to an embodiment of the disclosure may include a first housing 510 (e.g., a first housing structure or a base housing), a second housing 520 (e.g., a second housing structure or a slide housing), and a rollable display 530 (e.g., a flexible display, an expandable display, or a stretchable display).

According to an embodiment of the disclosure, the rollable display 530 may be disposed to be supported by at least a portion of the first housing 510 and the second housing 520.

According to an embodiment of the disclosure, the first housing 510 and the second housing 520 may be mutually coupled. For example, the second housing 520 may be coupled to the first housing 510 to be movable in a designated direction (e.g., in the x-axis direction) and within a designated distance.

According to an embodiment of the disclosure, the electronic device 500 may include a bendable member (or bendable support member) (e.g., a multi-joint hinge module or a multi-bar assembly) to define at least partially the same plane with at least a portion of the first housing 510 in the first state (e.g., the slide-out state). The bendable member (or bendable support member) (e.g., a multi-joint hinge module or a multi-bar assembly) may be at least partially received in a second space 5201 of the second housing 520 in the second state (e.g., the slide-in state).

According to an embodiment of the disclosure, at least a portion of the second housing 520 may be received in a first space 5101 of the first housing 510, thereby changing to the second state (e.g., the slide-in state).

According to an embodiment of the disclosure, in the first state (e.g., the slide-out state), at least a portion of the rollable display 530 may be disposed to be visible from the outside while being supported by the bendable member configured to at least partially configure the same plane with first housing 510.

According to an embodiment of the disclosure, in the second state (e.g., the slide-in state), at least a portion of the rollable display 530 may be received in an internal space 5201 of the second housing 520 while being supported by the bendable member so as to be disposed to be invisible from the outside.

According to an embodiment of the disclosure, in the first state (e.g., the slide-out state) of the electronic device 500, a screen size (e.g., a screen area) of the rollable display 530 visible to the outside may be maximized (e.g., substantially maximum).

According to an embodiment of the disclosure, in the second state (e.g., the slide-in state) of the electronic device 500, a screen size (e.g., a screen area) of the rollable display 530 visible to the outside may be minimized (e.g., substantially minimum).

According to an embodiment of the disclosure, in a third state (e.g., an intermediate state) of the electronic device 500, a screen size (e.g., a screen area) of the rollable display 530 visible to the outside may be smaller than that of the first state (e.g., the slide-out state) and larger than that of the second state (e.g., the slide-in state). For example, in the third state (e.g., the intermediate state) of the electronic device 500, a screen size (e.g., a screen area) of the rollable display 530 visible to the outside may be smaller than the maximum size (e.g., the maximum screen area) and larger than the minimum size (e.g., the minimum screen area).

According to an embodiment of the disclosure, the electronic device 500 may include a front surface 500a (e.g., a first surface or a surface on which a screen is displayed), a rear surface 500b (e.g., a second surface) facing opposite to the front surface 500a, and a lateral surface (not shown) surrounding a space between the front surface 500a and the rear surface 500b.

According to an embodiment of the disclosure, the electronic device 500 may include the first housing 510 including a first lateral member 511 and the second housing 520 including a second lateral member 521.

According to an embodiment of the disclosure, the first lateral member 511 may include a first lateral surface 5111 having a first length along a first direction (e.g., the x-axis direction), a second lateral surface 5112 extending from the first lateral surface to have a second length longer than the first length along a direction (e.g., the y-axis direction) substantially perpendicular to the first lateral surface 5111, and a third lateral surface 5113 extending from the second lateral surface 5112 to be substantially perpendicular to the first lateral surface 5111 and having the first length.

According to an embodiment of the disclosure, the first lateral member 511 may be at least partially made of a conductive material (e.g., a metal). According to an embodiment of the disclosure, at least a portion of the first lateral member 511 may include a first support member 512 extending to at least a portion of the first space 5101 of the first housing 510.

According to an embodiment of the disclosure, the second lateral member 521 may include a fourth lateral surface 5211 at least partially corresponding to the first lateral surface 5111 and having a third length, a fifth lateral surface 5212 extending from the fourth lateral surface 5211 in a direction substantially parallel to the second lateral surface 5112 and having a fourth length greater than the third length, and a sixth lateral surface 5213 extending from the fifth lateral surface 5212 to correspond to the third lateral surface 5113 and having the third length.

According to an embodiment of the disclosure, the second lateral member 521 may be at least partially made of a conductive material (e.g., a metal). According to an embodiment of the disclosure, at least a portion of the second lateral member 521 may include a second support member 522 extending to at least a portion of the second space 5201 of the second housing 520.

According to an embodiment of the disclosure, the first lateral surface 5111 and the fourth lateral surface 5211, and the third lateral surface 5113 and the sixth lateral surface 5213 may be slidably coupled to each other. According to an embodiment of the disclosure, in the second state (e.g., the slide-in state), the fourth lateral surface 5211 may be disposed to be substantially invisible from the outside by overlapping the first lateral surface 5211.

According to an embodiment of the disclosure, in the second state (e.g., the slide-in state), the sixth lateral surface 5213 may be disposed to be substantially invisible from the outside by overlapping the third lateral surface 5113. According to an embodiment of the disclosure, in the second state (e.g., the slide-in state), at least a portion of the fourth lateral surface 5211 and the sixth lateral surface 5213 may be arranged to be at least partially visible from the outside.

According to an embodiment of the disclosure, in the second state (e.g., the slide-in state), the second support member 522 may be disposed to be substantially invisible from the outside by overlapping the first support member 512. For example, in the second state (e.g., the slide-in state), a portion of the second support member 522 may be disposed to be invisible from the outside by overlapping the first support member 512. A remaining portion of the second support member 522 may be disposed to be visible from the outside.

According to an embodiment of the disclosure, the electronic device may include a rear cover 513 disposed on at least a portion of the first housing 510 at the rear surface 500b. According to an embodiment of the disclosure, the rear cover 513 may be disposed through at least a portion of the first support member 512.

According to an embodiment of the disclosure, the rear cover 513 may be integrally formed with the first lateral member 511.

According to an embodiment of the disclosure, the rear cover 513 may be made of polymer, coated or colored glass, ceramic, or a metal (e.g., aluminum, stainless steel (STS), or magnesium), or a combination of at least two of the aforementioned materials. According to an embodiment of the disclosure, the rear cover 513 may be extended to at least a portion of the first lateral member 511.

According to an embodiment of the disclosure, at least a portion of the first support member 512 may be replace by the rear cover 513. According to an embodiment of the disclosure, the electronic device 500 may include another rear cover (e.g., a second rear cover) which is disposed on at least a portion of the second support member 522 in the second housing 520 or replaces at least a portion of the second support member 522.

According to an embodiment of the disclosure, the rollable display 530 may include a first part 530a (e.g., a flat part) and a second part 530b (e.g., a bendable part) extending from the first part 230a. For example, the first part 530a (e.g., a flat part) may be disposed to be always visible from the outside. For example, the second part 530b (e.g., a bendable part) may extend from the first part 530a and be at least partially received in the second space 5201 of the second housing 520 such that at least a portion thereof is not visible from the outside in the second state (e.g., the slide-in state).

According to an embodiment of the disclosure, the first part 530a may be disposed to be supported by the first housing 510.

According to an embodiment of the disclosure, the second part 530b may be disposed to be supported at least partially by the bendable member.

According to an embodiment of the disclosure, the rollable display 530 may be slid out (e.g., screen extension) by moving the second housing 520 along a designated first direction (direction \textcircled{1}). The display 530 may be extended from the first part 530a while receiving support from the bendable member in a state where the second housing 520 is slid out along the designated first direction (direction \textcircled{1}). The rollable display 530 may configure substantially the same plane as the first part 530a and may be disposed so as to be visible from the outside.

According to an embodiment of the disclosure, the rollable display 530 may be slid in (e.g., screen reduction) by moving the second housing 520 along a designated second direction (direction \textcircled{2}). In a state in which the second housing 520 is slid-in along the second direction (direction \textcircled{2}), the designated second part 530b of the rollable display 530 may be received in the second space 5201 of the second housing 520 and disposed to be invisible from the outside. Accordingly, the electronic device 500 may induce a display area of the rollable display 530 to be variable according to the second housing 520 moving from the first housing 510 along a designated direction (e.g., the x-axis direction) in a sliding manner.

According to an embodiment of the disclosure, the first housing 510 and the second housing 520 may operate in a sliding manner to allow a whole width thereof to be variable with respect to each other.

According to an embodiment of the disclosure, in the first state (e.g., the slide-out state), the electronic device 500 may be configured to have a third width W3 greater than the first width W1 as at least a portion of the bendable member received in the internal space of the second housing 520 is moved to have an additional second width W2. For example, the rollable display 530 may have a display area substantially corresponding to the first width W1 in the second state (e.g., the slide-in state). The rollable display 530 may have an extended display area substantially corresponding to the third width W3 in the first state (e.g., the slide-out state).

According to an embodiment of the disclosure, in the second state (e.g., the slide-in state), the electronic device 500 may be configured to have a first width W1 from the second lateral surface 5112 to the fifth lateral surface 5212.

According to an embodiment of the disclosure, a slide-in/slide-out operation of the electronic device 500 may be automatically preformed. For example, in case of detecting a triggering operation for converting from the second state (e.g., the slide-in state) into the first state (e.g., the slide-out state) when a driving module is not operated, the electronic device 500 may operate the driving module disposed inside the electronic device 500. For example, in case of detecting a triggering operation for converting from the first state (e.g., the slide-out state) into the second state (e.g., the slide-in state) when a driving module is not operated, the electronic device 500 may operate the driving module disposed inside the electronic device 500.

According to an embodiment of the disclosure, the triggering operation of the slide-out/slide-in of the rollable display may include an operation of detecting a movement distance by which the second housing is moved in a second direction (e.g., direction \textcircled{2}) in which the second housing is to be slid in by a push-pull section. For example, the electronic device 500 may operate or stop the driving module through a driving motor control module operatively connected to a processor (e.g., the processor 120 in FIG. 1) and controlling a driving motor of the driving module.

According to an embodiment of the disclosure, the electronic device 500 may include at least one of an audio input device (e.g., a microphone 503), an audio output device (e.g., a call receiver 506 or a speaker 507), a sensor module 504 or 517, a camera module (e.g., a first camera module 505 or a second camera module 516), a connector port 508, a key input device (not shown), or an indicator (not shown) each of which is disposed in the first space 5101 of the first housing 510. In an embodiment of the disclosure, the electronic device 500 may be configured to omit at least one of the above-described components or additionally include other components. In an embodiment of the disclosure, at least one of the aforementioned components may be disposed in the second space 5201 of the second housing 520.

According to an embodiment of the disclosure, the audio input device may include the microphone 503. In an embodiment of the disclosure, the audio input device (e.g., the microphone 503) may include multiple microphones arranged so as to detect a direction of a sound. The sound output device may include, for example, the call receiver 506 and the speaker 507. According to an embodiment of the disclosure, the speaker 507 may face the outside through at least one speaker hole disposed in the first housing 510 in the first state (e.g., the slide-out state).

According to an embodiment of the disclosure, the connector port 508 (e.g., a universal serial bus (USB) type C terminal) may face the outside through at least one connector hole port provided in the first housing 510 in the first state (e.g., the slide-out state).

According to an embodiment of the disclosure, the call receiver 506 may include a speaker (e.g., a piezo speaker) operating without a separate speaker hole.

According to an embodiment of the disclosure, the sensor module 504 or 517 may generate an electrical signal or a data value corresponding to an internal operation state or external environment state of the electronic device 500. For example, the sensor module 504 or 517 may include a first sensor module 504 (e.g., a proximity sensor or an illuminance sensor) disposed on the front surface 500a of the electronic device 500 and/or a second sensor module 517 (e.g., a heart rate monitoring (HRM) sensor) disposed on the rear surface 500b of the electronic device 500.

According to an embodiment of the disclosure, the first sensor module 504 may be disposed under (e.g., downward in the z-axis direction) the rollable display 530 on the front surface 500a of the electronic device 500.

According to an embodiment of the disclosure, a digitizer may be disposed under (e.g., downward in the z-axis direction) the rollable display (530).

According to an embodiment of the disclosure, the first sensor module 504 and/or the second sensor module 517 may include at least one of a gesture sensor, a gyro sensor, a grip sensor, a color sensor, an infrared (IR) sensor, an illuminance sensor, an ultrasonic sensor, a proximity sensor, a biometric sensor (e.g., an iris recognition sensor), a distance detection sensor (e.g., a time of flight (TOF) sensor, or a light detection and ranging (LiDAR) sensor), a barometric sensor, a magnetic sensor (e.g., a 6-axis sensor, or a geomagnetic sensor), an acceleration sensor, a temperature sensor, a humidity sensor, or a fingerprint recognition sensor.

According to an embodiment of the disclosure, the camera module may include a first camera module 505 disposed at the front surface 500a of the electronic device 500 and a second camera module 516 disposed on the rear surface 500b. According to an embodiment of the disclosure, the electronic device 500 may include a flash 518 located adjacent to the second camera module 516. According to an embodiment of the disclosure, the camera modules 505 or 516 may include one or more of lenses, an image sensor, memory, and/or an image signal processor.

According to an embodiment of the disclosure, the first camera module 505 may be disposed under the rollable display 530 and configured to photograph a subject through a portion of an activation area of the rollable display 530. According to an embodiment of the disclosure, the flash 518 may include, for example, a light-emitting diode or a xenon lamp.

According to an embodiment of the disclosure, the first camera module 505 among the camera modules and a specific sensor module 504 among the sensor modules 504 and 517 may be disposed to detect an external environment through the rollable display 530. For example, the first camera module 505 or the specific sensor module 504 may be disposed in the first space 5201 of the first housing 510 to be in contact with the external environment through a transmission area or a perforated opening formed on the rollable display 530.

According to an embodiment of the disclosure, an area facing the first camera module 505 of the rollable display 530 may correspond to a portion of an area configured to display contents, and may be formed to be a transmission area having predetermined transmittance.

According to an embodiment of the disclosure, the transmission area of the rollable display 530 may be configured to have transmittance in the range of about 5% to about 20%. Such transmission area may include an area overlapping an effective area (e.g., a view-angle region) of the first camera module 505 through which light for imaging to an image sensor to generate an image passes. For example, the transmission area of the rollable display 530 may include an area having a lower pixel density and/or wire density than a peripheral area. For example, the transmission area may be substituted with the aforementioned opening. For example, a specific camera module 505 may include an under-display camera (UDC).

According to an embodiment of the disclosure, a specific sensor module 504 may be disposed in the internal space of the electronic device 500 to perform functions thereof without being visually exposed through the rollable display 530.

According to various embodiments of the disclosure, the electronic device 500 may include at least one antenna A1 or A2 electrically connected to a wireless communication circuit (e.g., the wireless communication module 192 in FIG. 1) disposed in the first space 5101 of the first housing 510.

According to an embodiment of the disclosure, at least one antenna A1 or A2 may include a first antenna A1 disposed in an upper area of the electronic device 500 and a second antenna A2 disposed in a lower area.

According to an embodiment of the disclosure, the electronic device 500 may further include at least one antenna disposed on the second lateral surface 5112 of the first housing 510 and/or the fifth lateral surface 5212 of the second housing 520.

According to an embodiment of the disclosure, the first antenna A1 may include a first conductive part 511 segmented through at least one non-conductive part 5111 or 5112 on the third lateral surface 5113 of the first lateral member 511.

According to an embodiment of the disclosure, the first conductive part 511 may be disposed to be segmented through a first non-conductive part 5111 and a second non-conductive part 5112 spaced a designated distance apart from each other and may be electrically connected to the wireless communication circuit (e.g., the wireless communication module 192 in FIG. 1).

According to an embodiment of the disclosure, the second antenna A2 may include a second conductive part 521 segmented through at least one non-conductive part 5211 or 5212 on the first lateral surface 5111 of the first lateral member 511.

According to an embodiment of the disclosure, the second conductive part 521 may be disposed to be segmented through a third non-conductive part 5211 and a fourth non-conductive part 5212 spaced a designated distance apart from each other and may be electrically connected to the wireless communication circuit (e.g., the wireless communication module 192 in FIG. 1).

According to an embodiment of the disclosure, the wireless communication circuit (e.g., the wireless communication module 192 in FIG. 1) may be configured to transmit or receive a wireless signal in a designated frequency band (e.g., about 800 MHz to 6000 MHz) (e.g., a legacy band) through the first conductive part 511 and/or the second conductive part 521.

According to an embodiment of the disclosure, the electronic device 500 may further include at least one antenna module (e.g., a 5G antenna module or antenna structure) disposed in the internal space (e.g., the first space 5101 or the second space 5201). The at least one antenna module (e.g., a 5G antenna module or antenna structure) may be disposed to transmit and receive a wireless signal in a frequency band ranging from about 3 GHz to 100 GHz through another wireless communication circuit (e.g., the wireless communication module 192 in FIG. 1).

The electronic device 500 according to an embodiment of the disclosure may include a driving module disposed in the internal space (e.g., the second space 5201) for the slide-in/slide-out operation.

According to an embodiment of the disclosure, the electronic device 500 may detect a triggering operation in which the second housing 520 is pressed in a second direction (e.g., direction \textcircled{2}) to be slid in by a push-pull section when the driving module is not driven and in the first state (e.g., the slide-out state). When the triggering operation is detected, the second housing 520 may be automatically slid in through the driving module (a push and pull-in operation) (e.g., a slide-in operation).

According to an embodiment of the disclosure, the electronic device 500 may use a push-pull operation as the triggering operation for driving the driving module. For example, the electronic device 500 may detect a triggering operation in which the second housing 520 is pressed in the second direction (e.g., direction \textcircled{2}) to be slid in by a push-pull section when the driving module is not driven and in the second state (e.g., the slide-in state). When the triggering operation is detected, the second housing 520 may be automatically slid out through the driving module (a push and pull-in operation) (e.g., a slide-out operation).

Accordingly, the electronic device 500 may provide an intuitive triggering means (switching mean) for the slide-in/slide-out operation to the user so as to provide intuitive and new experience and help to improve convenience of use.

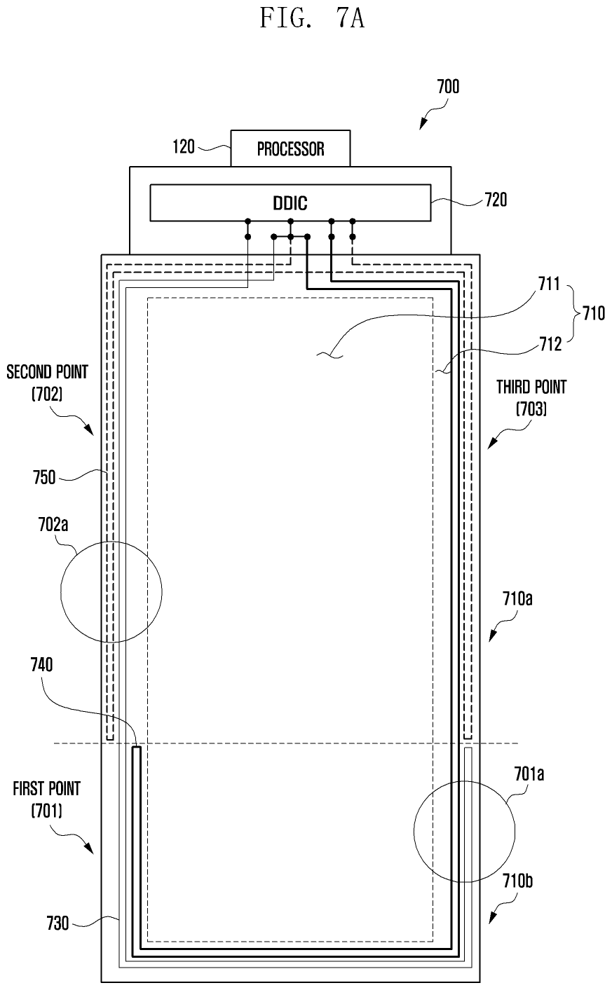

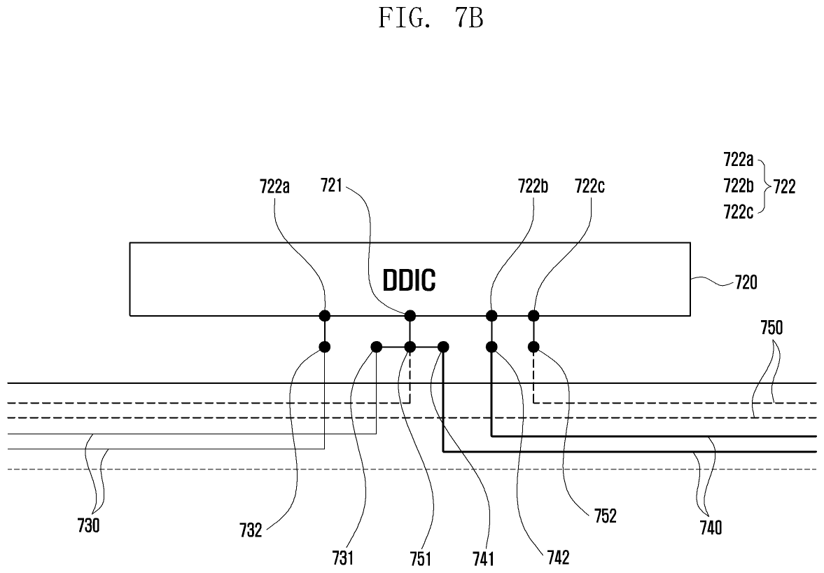

FIG. 7A is a view illustrating an electronic device according to an embodiment of the disclosure.

FIG. 7B is a view illustrating that an DDIC and multiple detection wires (e.g., conductive wires, metal wires, module crack detection (MCD) wires, circuit wires, or circuit patterns) are connected to each other according to an embodiment of the disclosure.

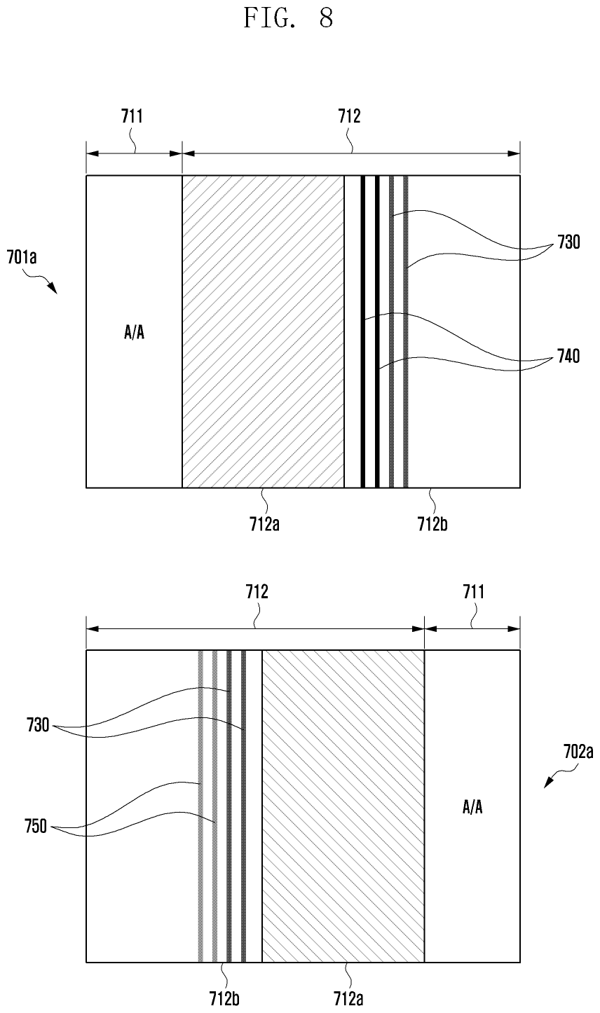

FIG. 8 is a view illustrating multiple detection wires (e.g., signal wires, conductive wires, metal wires, module crack detection (MCD) wires, circuit wires, or circuit patterns) arranged on a second part (e.g., a non-display part or bezel area) of a rollable display according to an embodiment of the disclosure.

FIG. 8 shows a portion 701a of multiple detection wires 730 and 740 arranged in the rolling part, and a portion 702a of the multiple detection wires 730 and 750 arranged in the fixed part 710a.

Referring to FIGS. 7A, 7B, and 8, the electronic device 700 (e.g., the electronic device 101 in FIG. 1, the electronic device 200 in FIGS. 2A, 2B, 3A, and 3B, or the electronic device 500 in FIGS. 5A to 6B) according to an embodiment of the disclosure may include a rollable display 710 (e.g., a flexible display, the rollable display 230 in FIG. 2A, or the rollable display 530 in FIG. 5A), a DDIC 720 (e.g., the DDIC 430 in FIG. 4), a processor 120 (e.g., the processor 120 in FIG. 1), a motor drive unit (e.g., the motor drive unit 770 in FIG. 9), and a motor (e.g., the motor 780 in FIG. 9).

For example, the rollable display 710 may include multiple layers (e.g., seven to twelve layers) including a display panel, which are stacked on an upper and/or lower portion through an adhesive member (e.g., a pressure sensitive adhesive (PSA)). For example, the multiple layers may include a window layer, a protection layer, or multiple functional layers. In order to improve the durability of a bendable area received in an internal space of the electronic device 700 in the slide-in state, the rollable display 710 may have at least one rigid reinforcing layer (e.g., a multi-bar or a support plate) added through the adhesive member. For example, the rollable display 710 may include a touch circuit (e.g., the touch circuit 450 in FIG. 4) configured to detect a user's touch.

For example, the processor 120 may be electrically connected to the DDIC 720 and control the operation of the DDIC 720. For example, the DDIC 720 may be electrically connected to the rollable display 710 and control the operation of the rollable display 710. A specific operation of the DDIC 720 will be referred to the description of the DDIC 430 of FIG. 4.

For example, the processor 120 may determine a state (e.g., the slide-out state, the slide-in state, and the intermediate state) of the electronic device 700 using a sensor module (e.g., the sensor module 176 in FIG. 1). The processor 120 may control the operation of the motor drive unit 770 to change the state (e.g., the slide-out state, the slide-in state, and the intermediate state) of the electronic device 700. The motor drive unit 770 may drive the motor 780 based on the control of the processor 120. The rollable display 710 may be slid out (e.g., screen extension) or slid in (e.g., screen reduction) by driving the motor 780.

According to an embodiment of the disclosure, the rollable display 710 (e.g., a flexible display) may include a first area 711 (e.g., a display area or an active area) where a screen is displayed, and a second area 712 (e.g., a non-display area, or a bezel area) arranged on an edge (e.g., the periphery) of the first area.

According to an embodiment of the disclosure, the rollable display 710 (e.g., a flexible display) may include a fixed part 710a and a rolling part 710b.

For example, the fixing part 710a of the rollable display 710 (e.g., a flexible display) may be visually exposed to the outside regardless of the first state (e.g., the slide-out state) and the second state (e.g., the slide-in state) of the electronic device 700.

For example, the rolling part 710b of the rollable display 710 (e.g., a flexible display) may be unfolded from the inside of the housings to the outside in the first state (e.g., the slide-out state) of the electronic device 700 and may be visually exposed to the outside. The rolling part 710b of the rollable display 710 (e.g., a flexible display) may be rolled and placed inside the housings in the second state (e.g., the slide-in state) of the electronic device 700 and may not be visually exposed to the outside.

According to an embodiment of the disclosure, when the electronic device 700 is changed from the first state (e.g., the slide-out state) to the second state (e.g., the slide-in state) and changed from the second state (e.g., the slide-in state) to the first state (e.g., the slide-out state), a crack (e.g., damage) may occur in the rollable display 710. In order to detect (or sense) the crack (e.g., damage) in the rollable display 710, multiple detection wires 730, 740, and 750 (e.g., signal wires) (e.g., conductive wires, metal wires, module crack detection (MCD) wires, circuit wires, or circuit patterns) may be arranged in the second area 712 (e.g., a non-display area or a bezel area).

According to an embodiment of the disclosure, the second area 712 (e.g., a non-display area or bezel region) of the rollable display 710 may include a first wire area 712a and a second wire area 712b.

For example, the first wire area 712a of the second area 712 may be arranged adjacent to the first area 711 (e.g., a display part or active area). Circuits, signal wires, power wires, circuit wires, and/or circuit patterns for driving sub-pixels arranged in the first area 711 (e.g., a display part or active area) may be arranged in the first wire area 712a.

For example, the second wire area 712b of the second area 712 may be arranged on the periphery of the first wire area 712a. In the second wire area 712b, multiple detection wires 730, 740, and 750 (e.g., signal wires, conductive wires, metal wires, module crack detection (MCD) wires, circuit wires, or circuit patterns) for detecting (or sensing) a crack (e.g., damage) of the rollable display 710 may be arranged.

According to an embodiment of the disclosure, the multiple detection wires 730, 740, and 750 arranged in the second area 712 (e.g., a non-display area or bezel area) of the rollable display 710 may be electrically connected (e.g., directly connected or indirectly connected) to the DDIC 720.

According to an embodiment of the disclosure, at least some of the multiple detection wires 730, 740, and 750 may be arranged to detect (or sense) a crack (e.g., damage) of the fixed part 710a. At least some of the multiple detection wires 730, 740, and 750 may be arranged to detect (or sense) a crack (e.g., damage) of the rolling part 710b. At least some of the multiple detection wires 730, 740, and 750 may be arranged to detect (or sense) a crack (e.g., damage) of the fixed part 710a and the rolling part 710b.

According to an embodiment of the disclosure, a first detection wire 730 and a second detection wire 740 may be arranged to detect (or sense) a crack (e.g., damage) in the rolling part 710b (e.g., a first point 701) of the rollable display 710.

According to an embodiment of the disclosure, the first detection wire 730, the second detection wire 740, and a third detection wire 750 may be arranged to detect a crack (e.g., damage) in a fixed part 710a (e.g., a second point 702 or a third point 703) of the rollable display 710. For example, the first detection wire 730 may be used to detect a crack (e.g., damage) in the fixed part 710a and the rolling part 710b of the rollable display 710. For example, the second detection wire 740 may be used to detect a crack (e.g., damage) in the fixed part 710a and the rolling part 710b of the rollable display 710. For example, the third detection wire 750 may be used to detect a crack (e.g., damage) in the fixed part 710a of the rollable display 710.

According to an embodiment of the disclosure, the first detection wire 730 may be arranged to correspond to the rolling part 710b (e.g., the first point 701) and the second point 702 of the fixed part 710a. The first detection wire 730 may be used to detect (or sense) a crack (e.g., damage) in the rolling part 710b (e.g., the first point 701) and the second point 702 of the fixed part 710a.

According to an embodiment of the disclosure, the second detection wire 740 may be arranged to correspond to the rolling part 710b (e.g., the first point 701) and the third point 703 of the fixed part 710a. The second detection wire 740 may be used to detect (or sense) a crack (e.g., damage) in the rolling part 710b (e.g., the first point 701) and the fixed part 710a (e.g., the third point 703).

According to an embodiment of the disclosure, the third detection wire 750 may be arranged to correspond to the second point 702 and the third point 703 of the fixed part 710a. The third detection wire 750 may be used to detect (or sense) a crack (e.g., damage) in the fixed part 710a.

For example, at least a portion of the first detection wire 730 may be arranged to surround the rolling part 710b (e.g., the first point 701) (e.g., correspond to rolling part 719b) in the second area 712 (e.g., a non-display part or bezel area). FIGS. 7A, 7B, and 8 illustrate an example where the first detection wire 730 includes a single wire. However, the disclosure is not limited thereto, and the first detection wire 730 may include two or more wires.

For example, the first detection wire 730 may be arranged to extend in length from a portion corresponding to the rolling part 710b (e.g., the first point 701) and surround a first lateral surface (e.g., the second point 702) of the fixed part 710a. For example, the first detection wire 730 may be arranged to surround the rolling part 710b and the first lateral surface (e.g., the second point 702) of the first area 711 (e.g., a display part or active area) (e.g., the first area 711).

For example, the second detection wire 740 may be arranged to extend in length from a portion corresponding to the rolling part 710b (e.g., the first point 701) and surround a second lateral surface (e.g., the third point 703) of the fixed part 710a. For example, the second detection wire 740 may be arranged to surround the rolling part 710b and the second lateral surface (e.g., the third point 703) of the first area 711 (e.g., a display part or active area). FIGS. 7A, 7B, and 8 illustrate an example where the second detection wire 740 includes a single wire. However, the disclosure is not limited thereto, and the second detection wire 740 may include two or more wires.

According to an embodiment of the disclosure, the third detection wire 750 may be arranged to surround the second point 702 and the third point 703 of the fixed part 710a. The third detection wire 750 may be arranged to surround (e.g., correspond to) the second area 712 (e.g., a non-display part or bezel area). FIGS. 7A, 7B, and 8 illustrate an example where the third detection wire 750 includes a single wire. However, the disclosure is not limited thereto, and the third detection wire 750 may include two or more wires.

For example, the first detection wire 730 may be arranged on the second area 712 (e.g., a non-display part or bezel area) so as to correspond to at least a portion of the rolling part 710b (e.g., the first point 701) and at least a portion of the second point 702 of the fixed part 710a.

For example, the second detection wire 740 may be arranged on the second area 712 (e.g., a non-display part or bezel area) so as to correspond to at least a portion of the rolling part 710b (e.g., the first point 701) and at least a portion of the third point 703 of the fixed part 710a.

For example, the third detection wire 750 may be arranged in the second area 712 (e.g., a non-display area or bezel area) so as to correspond only to the second point 702 and the third point 701 of the fixed part 710a. The third detection wire 750 may not be arranged in an area corresponding to the rolling part 710b (e.g., the first point 701).

According to an embodiment of the disclosure, the DDIC 720 may include a detection signal output terminal 721 and a detection signal input terminal 722. For example, a first side 731 of the first detection wire 730, a first side 741 of the second detection wire 740, and a first side 751 of the third detection wire 750 may be commonly connected (e.g., electrically connected) to the detection signal output terminal 721 of the DDIC 720. Without limitation thereto, the DDIC 720 may include multiple detection signal output terminals and the first side 731 of the first detection wire 730, the first side 741 of the second detection wire 740, and the first side 751 of the third detection wire 750 may be electrically connected (e.g., directly connected or indirectly connected) to each detection signal output terminal. For example, the detection signal input terminal 722 of the DDIC 720 may include a first detection signal input terminal 722a, a second detection signal input terminal 722b, and a third detection signal input terminal 722c. The second side 732 of the first detection wire 730 may be electrically connected (e.g., directly connected or indirectly connected) to the first detection signal input terminal 722a. The second side 742 of the second detection wire 740 may be electrically connected (e.g., directly connected or indirectly connected) to the second detection signal input terminal 722b. The second side 752 of the third detection wire 750 may be electrically connected (e.g., directly connected or indirectly connected) to the third detection signal input terminal 722c.

According to an embodiment of the disclosure, the electronic device 700 according to an embodiment of the disclosure may include a separate driving IC other than a DDIC 720. The separate driving IC may be used to supply a detection signal to the first detection wire 730, the second detection wire 740, and the third detection wire 750. The separate driving IC may be used to receive feedback (e.g., a feedback signal) for the detection signal from each of the first detection wire 730, the second detection wire 740, and the third detection wire 750.

According to an embodiment of the disclosure, the first detection wire 730 and the second detection wire 740 may have different line widths (e.g., different line widths of the detection wires). For example, the second detection wire 740 positioned more inward (e.g., adjacent to the first area 711 (e.g., a display part or active area)) than the first detection wire 730 may have a first line width. The first detection wire 730 positioned more outward than the second detection wire 740 may have a second line width that is greater than the first line width. For example, the second line width may be at least twice the first line width or more. For example, a spacing between the first detection wire 730 and the second detection wire 740 may be constant. For example, the spacing between the first detection wire 730 and the second detection wire 740 may vary depending on the location.

According to an embodiment of the disclosure, the first detection wire 730 and the third detection wire 750 may have different line widths. For example, the first detection wire 730 positioned more inward (e.g., adjacent to the first area 711 (e.g., a display part or active area)) than the third detection wire 750 may have the second line width. The third detection wire 750 positioned more outward than the first detection wire 730 may have a third line width that is greater than the second line width. For example, the third line width may be at least twice the second line width or more.

The line width of the first detection wire 730, positioned more outward than the second detection wire 740, is relatively wider (e.g., at least twice as wide) and the line width of the third detection wire 750, which is positioned more outward than the first detection wire 730, thereby reducing damage to the detection wires (e.g., sensing wires) caused by handling the rollable display 710 during the manufacturing process. The rollable display 710 (e.g., a flexible display) in FIG. 7A may be applied to the rollable display 230 in FIGS. 2A, 2B, 3A, and 3B.

FIG. 9 is a view illustrating a method for determining a crack (e.g., damage) in a rollable display in an electronic device according to an embodiment of the disclosure.

Referring to FIGS. 7A, 7B, 8, and 9, the electronic device 700 (e.g., the electronic device 101 in FIG. 1, the electronic device 200 in FIGS. 2A, 2B, 3A, and 3B, the electronic device 500 in FIGS. 5A, 5B, 6A, and 6B, or the electronic device 700 in FIGS. 7A and 7B) according to an embodiment of the disclosure may include a rollable display 710 (e.g., a flexible display, the rollable display 230 in FIG. 2A, or the rollable display 530 in FIG. 5A), a DDIC 720 (e.g., the DDIC 430 in FIG. 4), a processor 120 (e.g., the processor 120 in FIG. 1), a motor drive unit (e.g., the motor drive unit 770 in FIG. 9), and a motor (e.g., the motor 780 in FIG. 9).

According to an embodiment of the disclosure, the detection signal input terminal 722 of the DDIC 720 may include a first detection signal input terminal 722a, a second detection signal input terminal 722b, and a third detection signal input terminal 722c. The second side (e.g., the second side 732 in FIG. 7B) of the first detection wire 730 may be electrically connected (e.g., directly connected or indirectly connected) to the first detection signal input terminal 722a. The second side (e.g., the second side 742 in FIG. 7B) of the second detection wire 740 may be electrically connected (e.g., directly connected or indirectly connected) to the second detection signal input terminal 722b. The second side (e.g., the second side 752 in FIG. 7B) of the third detection wire 750 may be electrically connected (e.g., directly connected or indirectly connected) to the third detection signal input terminal 722c.

According to an embodiment of the disclosure, the DDIC 720 may supply detection signals (e.g., bias voltages or sensing signals) to detect (or sense) a crack (e.g., damage) in the rollable display 710 to a first side 731, 741, or 751 of each of the multiple detection wires 730, 740, and 750. For example, the DDIC 720 may supply detection signals (e.g., bias voltages or sensing signals) commonly to the first side 731, 741, or 751 of each of the multiple detection wires 730, 740, and 750.

According to an embodiment of the disclosure, the DDIC 720 may receive feedback (e.g., receive a feedback signal, a feedback voltage, a bias voltage, or a sensing signal) for detection signals from the second side 732, 742, or 752 of each of the multiple detection wires 730, 740, and 750.

For example, the DDIC 720 may convert detection signals (e.g., feedback signals, feedback voltages, bias voltages, or sensing signals) fed back through the multiple detection wires 730, 740, and 750 into digital detection values (e.g., digital sensing values). The DDIC 720 may provide the detection values (e.g., sensing values) (e.g., signal phase values) for the multiple detection wires 730, 740, and 750 to the processor 120.

For example, the DDIC 720 may supply first detection signals (e.g., bias voltages, or sensing signals) to detect (or sense) a crack (e.g., damage) in the rollable display 710 to the first side 731 of the first detection wire 730. The DDIC 720 may receive feedback for the first detection signals (e.g., feedback signals, bias voltages, or sensing signals) from the second side 732 of the first detection wire 730.

For example, if there is no crack (e.g., damage) in the first detection wire 730, the DDIC 720 may receive feedback (e.g., receive a feedback signal, a feedback voltage, a bias voltage, or a sensing signal) for the first detection signal.

For example, if a crack (e.g., damage) occurs in the first detection wire 730, the DDIC 720 may not receive feedback for the first detection signal (e.g., a feedback signal, a feedback voltage, a bias voltage, or a sensing signal).

According to an embodiment of the disclosure, the DDIC 720 may convert first detection signals (e.g., first sensing signals) fed back through the first detection wire 730 into first detection values (e.g., first sensing values). The DDIC 720 may provide the first detection values (e.g., first sensing values) (e.g., first signal phase values) for the first detection wires 730 to the processor 120.

For example, the DDIC 720 may supply second detection signals (e.g., bias voltages, or sensing signals) to detect (or sense) a crack (e.g., damage) in the rollable display 710 to the first side 741 of the second detection wire 740. The DDIC 720 may receive feedback (e.g., receive a feedback signal, a feedback voltage, a bias voltage, or a sensing signal) for the second detection signals from the second side 742 of the second detection wire 740.

For example, if there is no crack (e.g., damage) in the second detection wire 740, the DDIC 720 may receive feedback (e.g., receive a feedback signal, a feedback voltage, a bias voltage, or a sensing signal) for the second detection signals.

For example, if a crack (e.g., damage) occurs in the second detection wire 740, the DDIC 720 may not receive feedback for the second detection signal (e.g., a feedback signal, a feedback voltage, a bias voltage, or a sensing signal).

For example, DDIC 720 may convert the second detection signal (e.g., a feedback signal, a feedback voltage, bias voltages, or a sensing signal) fed back through the second detection wire 740 into a second detection value (e.g., a sensing value). The DDIC 720 may provide the second detection value (e.g., a second sensing value) (e.g., a second signal phase value) for the second detection wire 740 to the processor 120.

For example, the DDIC 720 may supply third detection signals (e.g., bias voltages, or sensing signals) to detect (or sense) a crack (e.g., damage) in the rollable display 710 to the first side 751 of the third detection wire 750. The DDIC 720 may receive feedback (e.g., receive a feedback signal, a feedback voltage, a bias voltage, or a sensing signal) for the third detection signals from the second side 752 of the third detection wire 750.

For example, if there is no crack (e.g., damage) in the third detection wire 750, the DDIC 720 may receive feedback (e.g., receive a feedback signal, a feedback voltage, a bias voltage, or a sensing signal) for the third detection signal.

For example, if a crack (e.g., damage) occurs in the third detection wire 750, the DDIC 720 may not receive feedback for the third detection signal (e.g., a bias voltage, a sensing signal, a feedback voltage, or a feedback signal).

For example, DDIC 720 may convert the third detection signals (e.g., bias voltages, sensing signals, feedback voltages, or feedback signals) fed back through the third detection wire 750 into a third detection value (e.g., a third sensing value). The DDIC 720 may provide the third detection value (e.g., a third sensing value) (e.g., a third signal phase value) for the third detection wire 750 to the processor 120. According to an embodiment of the disclosure, the DDIC 720 may supply the same detection signal (e.g., a bias voltage, or sensing signal) to the first detection wire 730, the second detection wire 740, and the third detection wire 750 through the detection signal output terminal 721.

For example, DDIC 720 may convert detection signals (e.g., bias voltages, sensing signals, feedback voltages, or feedback signals) fed back through the first detection wire 730 into first detection values (e.g., first sensing values). The DDIC 720 may provide the first detection values (e.g., first sensing values) (e.g., first signal phase values) for the first detection wires 730 to the processor 120.

For example, DDIC 720 may convert detection signals (e.g., bias voltages, sensing signals, feedback voltages, or feedback signals) fed back through the second detection wire 740 into second detection values (e.g., second sensing values). The DDIC 720 may provide the second detection value (e.g., a second sensing value) (e.g., a second signal phase value) for the second detection wires 740 to the processor 120.

For example, DDIC 720 may convert the third detection signal (e.g., a bias voltage, a sensing signal, as feedback voltage, or a feedback signal) fed back through the third detection wire 750 into third detection values (e.g., third sensing values). The DDIC 720 may provide the third detection value (e.g., a third sensing value) (e.g., a third signal phase value) for the third detection wire 750 to the processor 120.

According to an embodiment of the disclosure, the processor 120 may analyze detection values (e.g., sensing values) for the multiple detection wires 730, 740, and 750 input from the DDIC 720. Based on an analysis result of the detection values (e.g., sensing values) for the multiple detection wires 730, 740, and 750, the processor 120 may determine a crack (e.g., damage) in each of the fixed part 710a and the rolling part 710a of the rollable display 710.

According to an embodiment of the disclosure, the processor 120 may determine a crack (e.g., damage) in the rolling part 710b (e.g., the first point 701) or the fixed part 710a (e.g., the second point 702) of the rollable display 710 based on the first detection value (e.g., the first sensing value).

For example, in case that the first detection value (e.g., the first sensing value) is equal to a preconfigured value (e.g., substantially equal to a value considering an error) when the processor 120 analyzes the first detection value (e.g., the first sensing value), the processor 120 may determine that no crack (e.g., damage) has occurred in the rolling part 710b (e.g., the first point 701) and the fixed part 710a (e.g., the second point 702).

For example, in case that the first detection value (e.g., the first sensing value) is not equal to a preconfigured value (or a phase of the signal is changed) when the processor 120 analyzes the first detection value (e.g., the first sensing value), the processor 120 may determine that a crack (e.g., damage) has occurred in at least a portion of the rolling part 710b (e.g., the first point 701) or at least a portion of the fixed part 710a (e.g., the second point 702).

According to an embodiment of the disclosure, the processor 120 may determine a crack (e.g., damage) in the rolling part 710b (e.g., the first point 701) or the fixed part 710a (e.g., the third point 703) of the rollable display 710 based on the second detection value (e.g., the second sensing value).

For example, in case that the second detection value (e.g., the second sensing value) is equal to a preconfigured value (e.g., substantially equal to a value considering an error) when the processor 120 analyzes the second detection value (e.g., the second sensing value), the processor 120 may determine that no crack (e.g., damage) has occurred in the rolling part 710b (e.g., the first point 701) and the fixed part 710a (e.g., the third point 703).

For example, in case that the second detection value (e.g., the second sensing value) is not equal to a preconfigured value (or a phase of the signal is changed) when the processor 120 analyzes the second detection value (e.g., the second sensing value), the processor 120 may determine that a crack (e.g., damage) has occurred in at least a portion of the rolling part 710b (e.g., the first point 701) or at least a portion of the fixed part 710a (e.g., the third point 703).

According to an embodiment of the disclosure, the processor 120 may determine a crack (e.g., damage) at the second point 702 and/or the third point 703 of the fixed part 710a of the rollable display 710.

For example, in case that the third detection value (e.g., the third sensing value) is equal to a preconfigured value (e.g., substantially equal to a value considering an error) when the processor 120 analyzes the third detection value (e.g., the third sensing value), the processor 120 may determine that no crack (e.g., damage) has occurred at the second point 702 and the third point 703 of the fixed part 710a.

For example, in case that the third detection value (e.g., the third sensing value) is not equal to a preconfigured value (or a phase of the signal is changed) when the processor 120 analyzes the third detection value (e.g., the third sensing value), processor 120 may determine that a crack (e.g., damage) has occurred in at least a portion (e.g., the second point 702 or the third point 703) of the fixed part 710a.

As such, the processor 120 may determine whether there is a crack (e.g., damage) at the second point 702 and the third point 701 of the fixed part 710a and whether there is a crack (e.g., damage) in the rolling part 710b (e.g., the first point 701) by analyzing the combination of the first detection value (e.g., the first sensing value), the second detection value (e.g., the second sensing value), and the third detection value (e.g., the third sensing value).

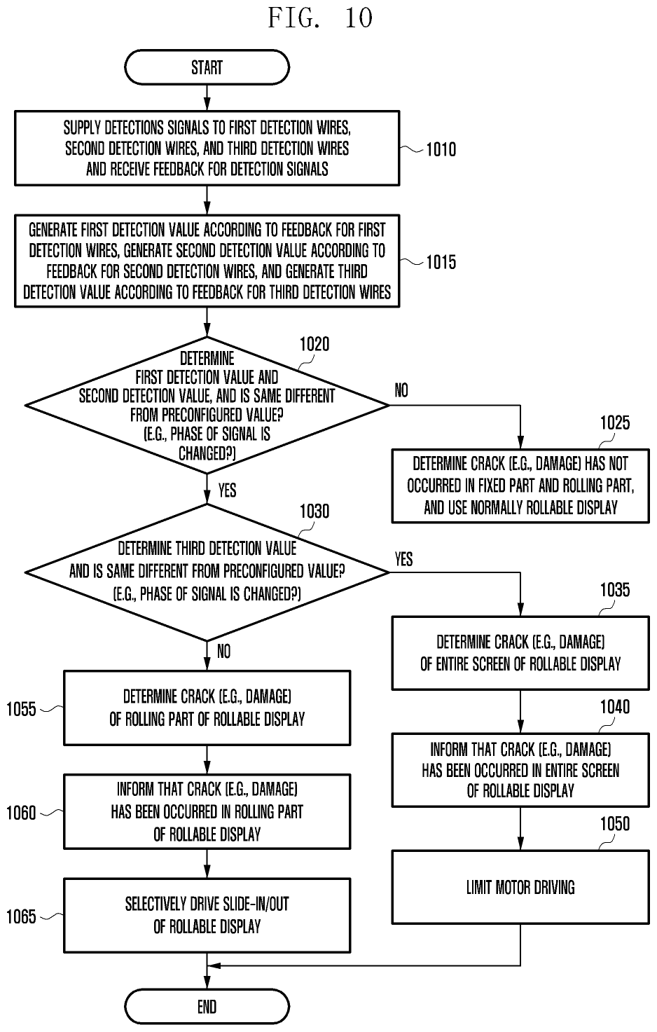

FIG. 10 is a flowchart illustrating an operating method of a rollable electronic device according to an embodiment of the disclosure.

Referring to FIGS. 7A, 7B, 9, and 10, in operation 1010, the DDIC 720 may supply detection signals (e.g., bias voltages or sensing signals) to the first detection wire 730, the second detection wire 740, and the third detection wire 750. The DDIC 720 may receive feedback for the detection signals (e.g., bias voltages or sensing signals) from each of the first detection wire 730, the second detection wire 740, and the third detection wire 750 (e.g., receive a bias voltage, a sensing signal, a feedback voltage, or a feedback signal).

In operation 1015, the DDIC 720 may generate a first detection value (e.g., a first signal phase value) according to feedback of the first detection wire 730. The DDIC 720 may generate a second detection value (e.g., a second signal phase value) according to feedback of the second detection wire 740. The DDIC 720 may generate a third detection value (e.g., a third signal phase value) according to feedback of the third detection wire 750. The DDIC 720 may provide the first detection value (e.g., the first signal phase value), the second detection value (e.g., the second signal phase value), and the third detection value (e.g., the third signal phase value) to the processor 120.

For example, the DDIC 720 may sequentially generate the first detection value (e.g., the first signal phase value), the second detection value (e.g., the second signal phase value), and the third detection value (e.g., the third signal phase value). The DDIC 720 may provide the first detection value (e.g., the first signal phase value), the second detection value (e.g., the second signal phase value), and the third detection value (e.g., the third signal phase value), which are sequentially generated, to the processor 120.

For example, the DDIC 720 may concurrently generate the first detection value (e.g., the first signal phase value), the second detection value (e.g., the second signal phase value), and the third detection value (e.g., the third signal phase value). The DDIC 720 may provide the first detection value (e.g., the first signal phase value), the second detection value (e.g., the second signal phase value), and the third detection value (e.g., the third signal phase value), which are concurrently generated, to the processor 120.

In operation 1020, the processor 120 may obtain the first detection value (e.g., the first signal phase value), the second detection value (e.g., the second signal phase value), and the third detection value (e.g., the third signal phase value) from the DDIC 720.

For example, the processor 120 may determine whether the first detection value (e.g., the first signal phase value) and the second detection value generation (e.g., the second signal phase value) are different from a preconfigured value. For example, the processor 120 may determine whether the phase of the signal has changed based on the first signal phase value according to the first detection value. The processor may determine whether the phase of the signal has changed based on the second signal phase value according to the second detection value.

As a result of the determination in operation 1020, in case that the first detection value (e.g., the first signal phase value) and the second detection value generation (e.g., the second signal phase value) are not different from the preconfigured value, the processor 120 may perform operation 1025.

As a result of the determination in operation 1020, in case that the phase of the signal has not changed based on the first signal phase value according to the first detection value and the second signal phase value according to the second detection value (e.g., in case that both the first signal phase value and the second signal phase value have not changed), the processor 120 may perform operation 1025.

In operation 1025, in case that both the first signal phase value and the second signal phase value have not changed, the processor 120 may determine that there is no crack (e.g., damage) in the fixed part 710a and the rolling part 710b of the rollable display 710. In case that no crack (e.g., damage) occurs in the fixed part 710a and the rolling part 710b of the rollable display 710, the processor 120 may control the rollable display 710 to be used normally.

As a result of the determination in operation 1020, in case that the first detection value (e.g., the first signal phase value) and the second detection value generation (e.g., the second signal phase value) are different from the preconfigured value (e.g., in case that at least one of the first signal phase value and the second signal phase value has changed), the processor 120 may perform operation 1030.

As a result of the determination in operation 1020, in case that at least one of the first signal phase value and the second signal phase value has changed based on the first signal phase value according to the first detection value or the second signal phase value according to the second detection value, the processor 120 may perform operation 1030.

In operation 1030, the processor 120 may determine whether the third detection value (e.g., the third signal phase value) is different from a preconfigured value. For example, the processor 120 may determine whether the phase of the signal has changed based on the third signal phase value according to the third detection value.

As a result of the determination in operation 1030, in case that the third detection value (e.g., the third signal phase value) is different from the preconfigured value, operation 1035 may be performed. In case that the phase of the signal has changed based on the third signal phase value according to the third detection value, the processor 120 may perform operation 1035.

In operation 1035, the processor 120 may determine that a crack (e.g., damage) has occurred in the entire screen (e.g., the fixed part 710a and the rolling part 710b) of the rollable display 710.

In operation 1040, the processor 120 may display a notification message on the screen regarding that a crack (e.g., damage) has occurred in the entire screen (e.g., the fixed part 710a and the rolling part 710b) of the rollable display 710. For example, the processor 120 may provide a comment in voice form regarding the occurrence of a crack (or damage) in the rollable display.

In operation 1050, in case that a crack (e.g., damage) occurs in the entire screen of the display 710 (e.g., the fixed part 710a and the rolling part 710b), the processor 120 may control the operation of the motor drive unit 770 to limit the driving of the motor 780. The processor 120 may limit the driving of the motor 780 to limit the slide-out/slide-in driving of the rollable display 710.

As a result of the determination in operation 1030, in case that the third detection value (e.g., the third signal phase value) is not different from the preconfigured value (e.g., in case that the third signal phase value is equal to the preconfigured value), operation 1055 may be performed.

In operation 1055, the processor 120 may determine that there is no crack (e.g., damage) in the fixed part 710a and a crack (e.g., damage) has occurred in the rolling part 710b of the rollable display 710.

For example, in case that a crack (e.g., damage) has occurred in the rolling part 710b of the display 710, the processor 120 may perform operation 1060.

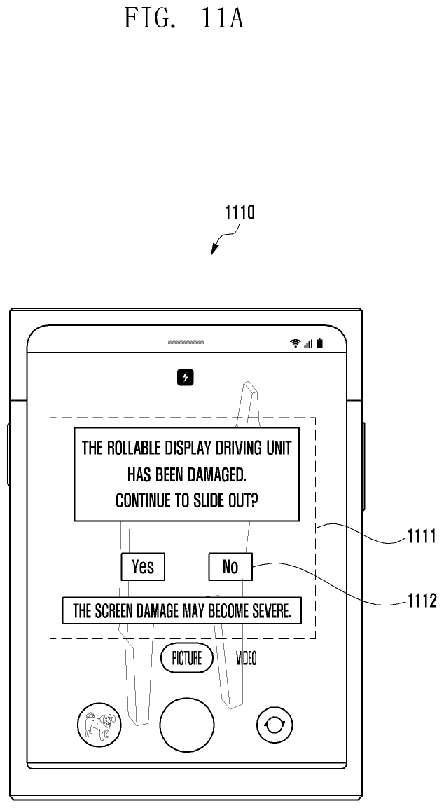

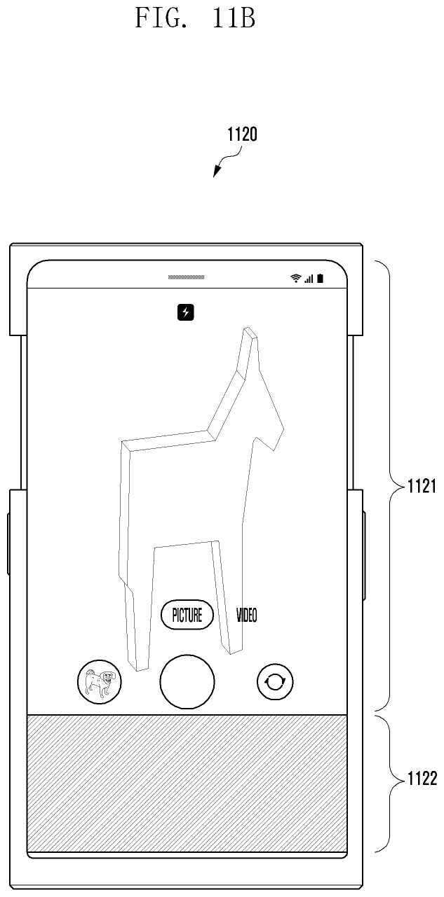

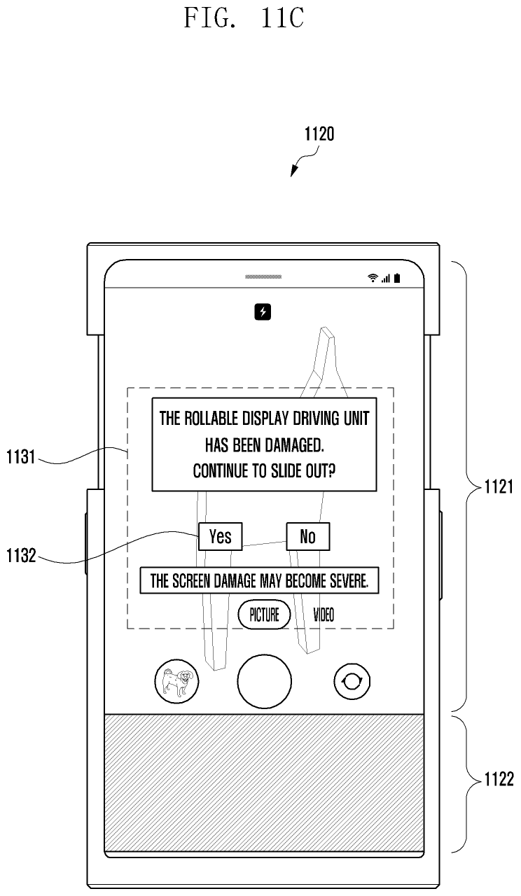

FIGS. 11A, 11B, and 11C are views illustrating a method for notifying occurrence of a crack (e.g., damage) in a rollable display and controlling a screen operation of the rollable display when a crack (e.g., damage) occurs in the rollable display according to various embodiments of the disclosure. The description will be given by combining FIGS. 11A and 11B.

Referring to FIGS. 10 and 11A, in operation 1060, the processor 120 may display a notification text 1111 on the screen regarding the occurrence of a crack (e.g., damage) in the rolling part 710b of the display 710 in the slide-in state 1110 (e.g., a screen reduction state) of the rollable display 710. For example, the processor 120 may provide a comment in voice form regarding the occurrence of a crack (or damage) in the rollable display.

In operation 1065, in case that a crack (e.g., damage) has occurred in the rolling part 710b of the display 710, the processor 120 may control the operation of the motor drive unit 770 to selectively limit the driving of the motor 780. The processor 120 may selectively limit the driving of the motor 780 to limit the slide-out/slide-in driving of the rollable display 710.

For example, the processor 120 may display a menu 1112 asking whether the user wants the slide-out and slide-in operation of the rollable display 710 even when a crack (e.g., damage) has occurred in the rolling part 710b of the display 710.

For example, the processor 120 may selectively drive the motor 780 based on the user's selection from the menu 1112 to enable the slide-out and slide-in operation of the rollable display 710.

For example, the processor 120 may limit the driving of the motor 780 based on the user's selection from the menu, thereby limiting the slide-out and slide-in operation of the rollable display 710.

Referring to FIG. 11B, in the slide-out state 1120 (e.g., the screen extension state) of the rollable display 710, if a crack (e.g., damage) has occurred in the rolling part 710b, the processor 120 may control screen use. Based on the occurrence of a crack (e.g., damage) in the rolling part 710b, the processor 120 may control the fixed part 710a to enable screen use (1121) and control the rolling part 710b to display a black screen (e.g., so that the screen is not displayed) (1122). The processor 120 may control an image (e.g., an image and a selection menu icon) that should have been displayed on the rolling part 710b to be displayed on the fixed part 710a where the crack (e.g., damage) has not occurred.

Referring to FIG. 11C, when the rollable display 710 is slid out 1120 and the screen is extended, the user may select the slide-in operation of the rollable display 710. In this case, the processor 120 may display a notification text 1131 on the screen regarding the occurrence of the crack (e.g., damage) in the rolling part 710b of the rollable display 710. For example, the processor 120 may provide a comment in voice form regarding the occurrence of a crack (or damage) in the rollable display. In addition, the processor 120 may also display a warning message on the screen (or provide the comment in voice form) regarding the possibility of screen damage becoming more severe when the slide-in operation of the rollable display 710 is selected.

For example, the processor 120 may display a menu 1132 asking whether the user wants the slide-out and slide-in operation of the rollable display 710 even when a crack (e.g., damage) has occurred in the rolling part 710b of the display 710.

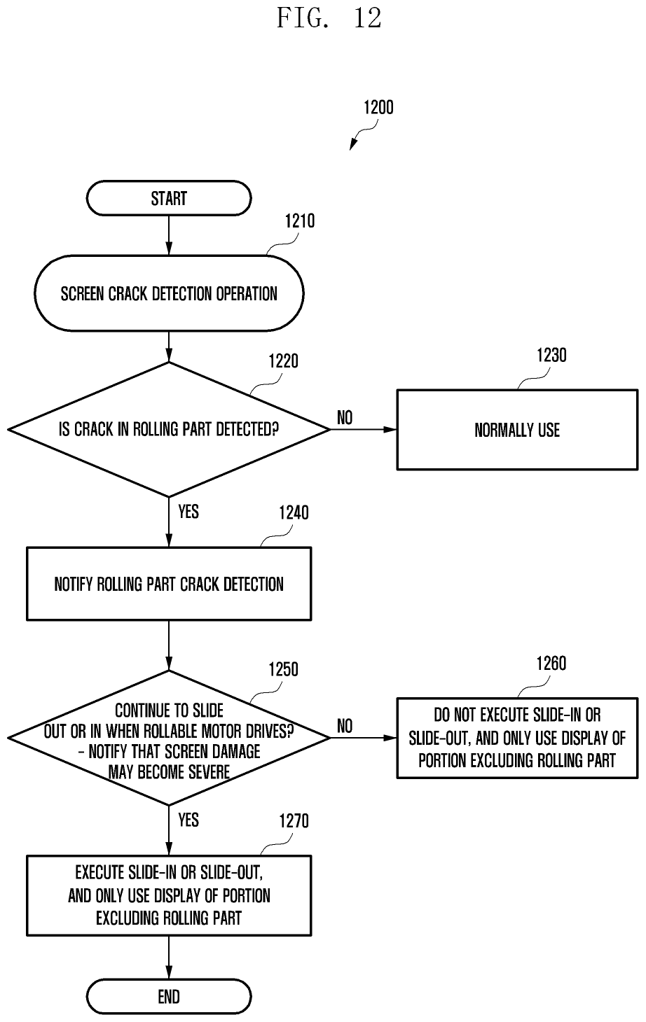

FIG. 12 is a flowchart 1200 illustrating a method for notifying occurrence of a crack (e.g., damage) in a rollable display and controlling a screen operation of the rollable display when a crack (e.g., damage) occurs in a rolling part of the rollable display according to an embodiment of the disclosure.

Referring to FIGS. 9 and 12, in operation 1210, the processor 120 may perform a crack (e.g., damage) detection operation for the rollable display 710.

In operation 1220, the processor 120 may determine whether a crack (e.g., damage) in the rolling part (e.g., the rolling part 710b in FIG. 7A) of the rollable display 710 is detected.

As a result of the determination in operation 1220, in case that a crack (e.g., damage) in the rolling part (e.g., rolling part 710b in FIG. 7A) of the rollable display 710 is not detected, the processor 120 may perform operation 1230.

In operation 1230, the processor 120 may control the rollable display 710 to be used normally.

As a result of the determination in operation 1220, in case that a crack (e.g., damage) in the rolling part (e.g., rolling part 710b in FIG. 7A) of the rollable display 710 is detected, the processor 120 may perform operation 1240.

In operation 1240, the processor 120 may display a phrase or graphic object on the screen or provide voice notification regarding the detection of a crack in the rolling part 710b of the rollable display 710.

In operation 1250, the processor 120 may display a menu on the screen for selecting whether to slide the rollable display 710 in/out, and drive the motor 780 based on the menu selection. In addition, the processor 120 may display a warning message (or output a warning voice notification) indicating that the sliding in/out of the rollable display 710 may make the screen damage severe when the motor 780 is driven.

In operation 1260, the processor 120 may control the operation of the motor 780 so that the slide in/out operation of the rollable display 710 is not executed. In addition, the operation of the DDIC 720 and the rollable display 710 may be controlled so that the fixed part (e.g., the fixed part 710a in FIG. 7A) in which no crack (e.g., damage) has occurred may be used, excluding the rolling part 710b in which a crack (e.g., damage) has occurred.

In operation 1270, the processor 120 may control the operation of the motor 780 to slide in/out the rollable display 710. In addition, the operation of the DDIC 720 and the rollable display 710 may be controlled so that the fixed part (e.g., the fixed part 710a in FIG. 7A) in which no crack (e.g., damage) has occurred may be used, excluding the rolling part 710b in which a crack (e.g., damage) has occurred.

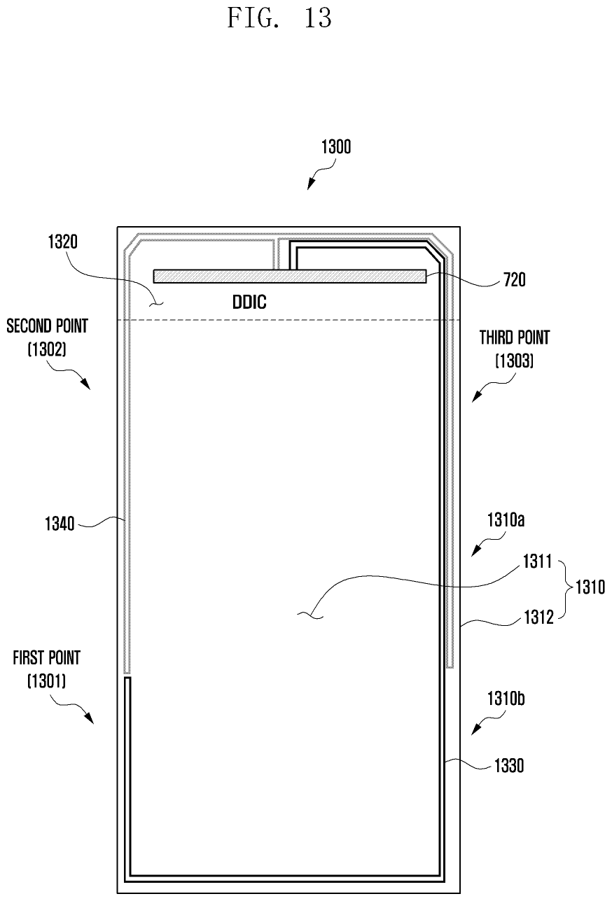

FIG. 13 is a view illustrating an electronic device according to an embodiment of the disclosure.

The electronic device 1300 in FIG. 13 may be at least partially similar to the electronic device 101 in FIG. 1 or the electronic device 700 in FIG. 7A or may further include other embodiments of an electronic device.

Referring to FIGS. 9, 10, 11A to 11C, 12, and 13, the electronic device 1300 (e.g., the electronic device 101 in FIG. 1, the electronic device 200 in FIGS. 2A, 2B, 3A, and 3B, the electronic device 500 in FIGS. 5A, 5B, 6A, and 6B, or the electronic device 700 in FIG. 7A) according to an embodiment of the disclosure may include a rollable display 1310 (e.g., a flexible display) (e.g., the rollable display 230 in FIG. 2A, the rollable display 530 in FIG. 5A, or the rollable display 710 in FIG. 7A), a DDIC 720 (e.g., the DDIC 430 in FIG. 4), a processor 120 (e.g., the processor 120 in FIG. 1), a motor drive unit 770, and a motor 780.

For example, the rollable display 1310 may include multiple layers (e.g., seven to twelve layers) including a display panel, which are stacked on an upper and/or lower portion through an adhesive member (e.g., a pressure sensitive adhesive (PSA)). For example, the multiple layers may include a window layer, a protection layer, or multiple functional layers. In order to improve the durability of a bendable area received in an internal space of the electronic device 1300 in the slide-in state, the rollable display 1310 may have at least one rigid reinforcing layer (e.g., a multi-bar or a support plate) added through the adhesive member.

For example, the processor 120 may be electrically connected to the DDIC 720 and control the operation of the DDIC 720. For example, the DDIC 720 may be electrically connected to the rollable display 1310 and operate the rollable display 1310. A specific operation of the DDIC 720 will be referred to the description of FIG. 4. For example, a flexible printed circuit board (FPCB) 1320 on which the DDIC 720 is disposed may be folded toward a rear surface of the display 1310 so that the DDIC 720 may be positioned on the rear surface of the display 1310.

For example, the processor 120 may determine a state (e.g., the slide-out state, the slide-in state, and the intermediate state) of the electronic device 1300 using a sensor module (e.g., the sensor module 176 in FIG. 1). The processor 120 may control the operation of the motor drive unit 770 to change the state (e.g., the slide-out state, the slide-in state, and the intermediate state) of the electronic device 1300. The motor drive unit 770 may drive the motor 780 based on the control of the processor 120. The rollable display 1310 may be slid out (e.g., screen extension) or slid in (e.g., screen reduction) by driving the motor 780.

According to an embodiment of the disclosure, the rollable display 1310 (e.g., a flexible display) may include a first area 1311 (e.g., a display area or an active area) where a screen is displayed, and a second area 1312 (e.g., a non-display area, or a bezel area) arranged on an edge of the first area.

According to an embodiment of the disclosure, the rollable display 1310 (e.g., a flexible display) may include a fixed part 1310a and a rolling part 1310b.

For example, the fixing part 1310a of the rollable display 1310 (e.g., a flexible display) may be visually exposed to the outside regardless of the first state (e.g., the slide-out state) and the second state (e.g., the slide-in state) of the electronic device 1300.

For example, the rolling part 1310b of the rollable display 1310 (e.g., a flexible display) may be unfolded from the inside of the housings to the outside in the first state (e.g., the slide-out state) of the electronic device 1300 and may be visually exposed to the outside. The rolling part 1310b of the rollable display 1310 (e.g., a flexible display) may be rolled and placed inside the housings in the second state (e.g., the slide-in state) of the electronic device 1300 and may not be visually exposed to the outside.

According to an embodiment of the disclosure, in order to detect (or sense) the crack (e.g., damage) in the rollable display 1310, detection wires 1330 and 1340 (e.g., signal wires) (e.g., conductive wires, metal wires, module crack detection (MCD) wires, circuit wires, or circuit patterns) may be arranged in the second area 1312 (e.g., a non-display area or a bezel area).

According to an embodiment of the disclosure, the second area 1312 (e.g., a non-display area or bezel region) of the rollable display 1310 may include a first wire area 712a (e.g., the first wire area 712a in FIG. 8) and a second wire area 712b (e.g., the second wire area 712b in FIG. 8).

For example, the first wire area 712a of the second area 712 may be arranged adjacent to the first area 1311 (e.g., a display part or active area). Circuits, signal wires, and power wires, circuit wires, and circuit patterns for driving sub-pixels arranged in the first area 1311 (e.g., a display part or active area) may be arranged in the first wire area 712a.

For example, the second wire area 712b of the second area 1312 may be arranged on the periphery of the first wire area 712a. In the second wire area 712b, detection wires 1330 and 1340 (e.g., signal wires) (e.g., conductive wires, metal wires, module crack detection (MCD) wires, circuit wires, or circuit patterns) for detecting (or sensing) a crack (e.g., damage) of the rollable display 1310 may be arranged.

According to an embodiment of the disclosure, the detection wires 1330 and 1340 arranged in the second area 1312 (e.g., a non-display area or bezel area) of the rollable display 1310 may be electrically connected (e.g., directly connected or indirectly connected) to the DDIC 720. For example, the electrical connection between the detection wires 1330 and 1340 and the DDIC 720 may refer to the description of FIG. 7B.

According to an embodiment of the disclosure, a single first detection wire 1330 may be arranged to detect (or sense) a crack (e.g., damage) in the rolling part 1310b (e.g., a first point 1301) of the rollable display 1310. For example, the first detection wire 1330 may be used to detect (or sense) a crack (e.g., damage) in a third point 1303 of the fixed part 1310a as well as in the rolling part 1310b.

According to an embodiment of the disclosure, a single second detection wire 1340 may be arranged to detect a crack (e.g., damage) in the fixed part 1310a (e.g., a second point 1302 or a third point 1303) of the rollable display 1310.

According to an embodiment of the disclosure, the first detection wire 1330 may be arranged to correspond to the rolling part 1310b (e.g., the first point 1301) and the third point 1303 of the fixed part 1310a. For example, the first detection wire 1330 may be used to detect (or sense) a crack (e.g., damage) in the rolling part 1301b and the third point 1303 of the fixed part 1310a.

According to an embodiment of the disclosure, the second detection wire 1340 may be arranged to correspond to the second point 1302 and the third point 1303 of the fixed part 1310a. For example, the second detection wire 1340 may be used to detect (or sense) a crack (e.g., damage) in the second point 1302 and the third point 1303 of the fixed part 1310a.

For example, at least a portion of multiple first detection wires 1330 may be arranged to surround (e.g., correspond to) the rolling part 1310b (e.g., the first point 701) in the second area 1312 (e.g., a non-display part or bezel area).

For example, at least a portion of the first detection wires 1330 may be arranged to extend in length from a portion corresponding to the rolling part 1310b (e.g., the first point 1301) and correspond to the third point 1303 of the fixed part 1310a.

For example, at least a portion of the second detection wires 1340 may be arranged to surround (e.g., correspond to) the second point 1302 and the third point 1303 of the fixed part 1310a in the second area 1312 (e.g., a non-display part or bezel area). For example, the second detection wire 1340 may be arranged to correspond only to the fixed part 1310a, and may not be arranged in an area corresponding to the rolling part 1310b (e.g., the first point (1301).

According to an embodiment of the disclosure, the DDIC 720 may supply detection signals (e.g., bias voltages or sensing signals) to detect (or sense) a crack (e.g., damage) in the rollable display 1310 to a first side of each of the detection wires 1330 and 1340. The DDIC 720 may receive feedback for the detection signals (e.g., receive a bias voltage, a detection signal, a feedback voltage, a feedback signal) from a second side of each of the detection wires 1330 and 1340.

For example, the DDIC 720 may convert detection signals (e.g., bias voltages, sensing signals, feedback voltages, or feedback signals) fed back through the detection wires 1330 and 1340 into digital detection values (e.g., digital sensing values). The DDIC 720 may provide the detection values (e.g., sensing values) (e.g., signal phase values) for the detection wires 1330 and 1340 to the processor 120.

For example, the DDIC 720 may supply first detection signals (e.g., bias voltages, or sensing signals) to detect (or sense) a crack (e.g., damage) in the rollable display 1310 to the first side of the first detection wire 1330. The DDIC 720 may receive feedback for the first detection signals (e.g., receive bias voltages, detection signals, feedback voltages, or feedback signals) from the second side of the first detection wire 1330.

For example, if there is no crack (e.g., damage) in the first detection wire 1330, the DDIC 720 may receive feedback (e.g., receive a bias voltage, a detection signal, a feedback voltage, or a feedback signal) for the first detection signal.

For example, if a crack (e.g., damage) has occurred in the first detection wire 1330, the DDIC 720 may not receive feedback for the first detection signal.

According to an embodiment of the disclosure, the DDIC 720 may convert a first detection signal (e.g., a first sensing signal) fed back through the first detection wire 1330 into a first detection value (e.g., a first sensing value). The DDIC 720 may provide the first detection value (e.g., the first sensing value) (e.g., first signal phase values) for the first detection wire 1330 to the processor 120.

For example, the DDIC 720 may supply second detection signals (e.g., bias voltages, or sensing signals) to detect (or sense) a crack (e.g., damage) in the rollable display 1310 to the first side of the second detection wire 1340. The DDIC 720 may receive feedback for the second detection signals (e.g., receive bias voltages, detection signals, feedback voltages, or feedback signals) from the second side of the second detection wire 1340.

For example, in case that no crack (e.g., damage) has occurred in the second detection wire 1340, the DDIC 720 may receive feedback for the second detection signal.

For example, if a crack (e.g., damage) has occurred in the second detection wire 1340, the DDIC 720 may not receive feedback for the second detection signal.

For example, the DDIC 720 may convert the second detection signal (e.g., a bias voltage, a sensing signal, a feedback voltage, or a feedback signal) fed back through the second detection wire 1340 into a second detection value (e.g., a sensing value). The DDIC 720 may provide the second detection value (e.g., a second sensing value) (e.g., a second signal phase value) for the second detection wire 1340 to the processor 120.

According to an embodiment of the disclosure, the DDIC 720 may supply the same detection signal (e.g., a bias voltage, or sensing signal) to the first detection wire 1330 and the second detection wire 1340.

According to an embodiment of the disclosure, the DDIC 720 may supply different detection signals (e.g., bias voltages, or sensing signals) to the first detection wire 1330 and the second detection wire 1340. The DDIC 720 may convert the detection signal (e.g., bias voltage, a sensing signal, a feedback voltage, or a feedback signal) fed back through the first detection wire 1330 into a first detection value (e.g., first sensing value). The DDIC 720 may provide the first detection value (e.g., the first sensing value) (e.g., first signal phase values) for the first detection wire 1330 to the processor 120.

The DDIC 720 may convert the detection signal (e.g., a bias voltage, a sensing signal, a feedback voltage, or a feedback signal) fed back through the second detection wire 1340 into a second detection value (e.g., a second sensing value). The DDIC 720 may provide the second detection value (e.g., a second sensing value) (e.g., a second signal phase value) for the second detection wire 1340 to the processor 120.

According to an embodiment of the disclosure, the processor 120 may analyze detection values (e.g., sensing values) for the detection wires 1330 and 1340 input from the DDIC 720. Based on an analysis result of the detection values (e.g., sensing values), the processor 120 may determine a crack (e.g., damage) in each of the fixed part 1310a and the rolling part 1310b of the rollable display 1310.

According to an embodiment of the disclosure, the processor 120 may determine a crack (e.g., damage) in the rolling part 1310b (e.g., the first point 1301) or the fixed part 1310a (e.g., the third point 1303) of the rollable display 1310 based on the first detection value (e.g., the first sensing value).

For example, in case that the first detection value (e.g., the first sensing value) is equal to a preconfigured value (e.g., substantially equal to a value considering an error) when the processor 120 analyzes the first detection value (e.g., the first sensing value), the processor 120 may determine that no crack (e.g., damage) has occurred in the rolling part 1310b (e.g., the first point 1301) and the fixed part 1310a (e.g., the third point 1303).

For example, in case that the first detection value (e.g., the first sensing value) is not equal to a preconfigured value (or a phase of the signal is changed) when the processor 120 analyzes the first detection value (e.g., the first sensing value), the processor 120 may determine that a crack (e.g., damage) has occurred in at least a portion of the rolling part 1310b (e.g., the first point 1301) or at least a portion of the fixed part 1310a (e.g., the third point 1303).

According to an embodiment of the disclosure, the processor 120 may determine a crack (e.g., damage) at the second point 1302 and/or the third point 1303 of the fixed part 1310a based on the second detection value (e.g., the second sensing value).

For example, in case that the second detection value (e.g., the second sensing value) is equal to a preconfigured value (e.g., substantially equal to a value considering an error) when the processor 120 analyzes the second detection value (e.g., the second sensing value), the processor 120 may determine that no crack (e.g., damage) has occurred at the second point 1302 and the third point 1303 of the fixed part 1310a.

For example, in case that the second detection value (e.g., the second sensing value) is not equal to a preconfigured value (or a phase of the signal is changed) when the processor 120 analyzes the second detection value (e.g., the second sensing value), the processor 120 may determine that a crack (e.g., damage) has occurred at the second point 1302 or the third point 1303.

As such, the processor 120 may determine whether there is a crack (e.g., damage) at the second point 1302 and the third point 1303 of the fixed part 1310a and whether there is a crack (e.g., damage) in the rolling part 1310b (e.g., the first point 1301) by combining and analyzing the first detection value (e.g., the first sensing value or the first signal phase value) and the second detection value (e.g., the second sensing value or the second signal phase value).

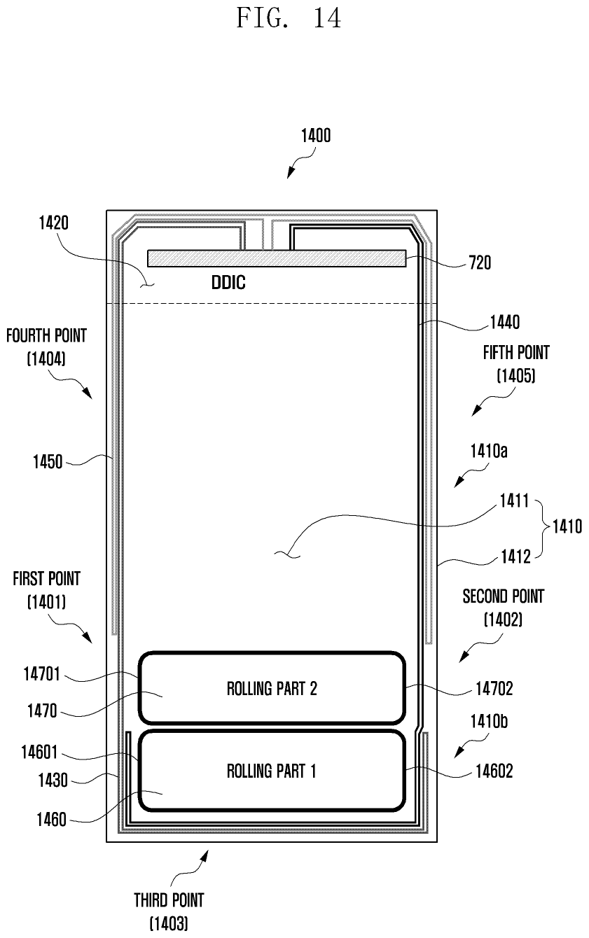

FIG. 14 is a view illustrating an electronic device according to an embodiment of the disclosure.

Referring to FIG. 14, an electronic device 1400 may be at least partially similar to the electronic device 101 in FIG. 1, the electronic device 700 in FIG. 7A, or the electronic device 1300 in FIG. 13 or may further include other embodiments of an electronic device.

Referring to FIGS. 9, 10, 11A to 11C, and 12 to 14, the electronic device 1400 (e.g., the electronic device 101 in FIG. 1, the electronic device 200 in FIGS. 2A, 2B, 3A, and 3B, the electronic device 500 in FIGS. 5A, 5B, 6A, and 6B, the electronic device 700 in FIG. 7A, or the electronic device 1400 in FIG. 13) according to an embodiment of the disclosure may include a rollable display 1410 (e.g., a flexible display) (e.g., the rollable display 230 in FIG. 2A, the rollable display 530 in FIG. 5A, the rollable display 710 in FIG. 7A, or the rollable display 1410 in FIG. 13), a DDIC 720 (e.g., the DDIC 430 in FIG. 4), a processor 120 (e.g., the processor 120 in FIG. 1), a motor drive unit 770, and a motor 780. For example, a flexible printed circuit board (FPCB) 1420 on which the DDIC 720 is disposed may be folded toward a rear surface of the display 1410 so that the DDIC 720 may be positioned on the rear surface of the display 1410.

According to an embodiment of the disclosure, the rollable display 1410 (e.g., a flexible display) may include a first area 1411 (e.g., a display area or an active area) where a screen is displayed, and a second area 1412 (e.g., a non-display area, or a bezel area) arranged on an edge of the first area.

According to an embodiment of the disclosure, the rollable display 1410 (e.g., a flexible display) may include a fixed part 1410a (e.g., the fixed part 1310a in FIG. 13) and a rolling part 1410b (e.g., the rolling part 1310b in FIG. 13).

For example, the fixing part 1410a of the rollable display 1410 (e.g., a flexible display) may be visually exposed to the outside regardless of the first state (e.g., the slide-out state) and the second state (e.g., the slide-in state) of the electronic device 1400.

For example, the rolling part 1410b of the rollable display 1410 (e.g., a flexible display) may be unfolded from the inside of the housings to the outside in the first state (e.g., the slide-out state) of the electronic device 1400 and may be visually exposed to the outside. The rolling part 1410b of the rollable display 1410 (e.g., a flexible display) may be rolled and placed inside the housings in the second state (e.g., the slide-in state) of the electronic device 1400 and may not be visually exposed to the outside.

According to an embodiment of the disclosure, in order to detect (or sense) the crack (e.g., damage) in the rollable display 1410, detection wires 1430, 1440, and 1450 (e.g., signal wires, conductive wires, metal wires, module crack detection (MCD) wires, circuit wires, or circuit patterns) may be arranged in the second area 1412 (e.g., a non-display area or a bezel area).

According to an embodiment of the disclosure, the second area 1412 (e.g., a non-display area or bezel region) of the rollable display 1410 may include a first wire area 712a (e.g., the first wire area 712a in FIG. 8) and a second wire area 712b (e.g., the second wire area 712b in FIG. 8).

For example, the first wire area 712a of the second area 1412 may be arranged adjacent to the first area 1411 (e.g., a display part or active area). Circuits, signal wires, and power wires for driving sub-pixels arranged in the first area 1411 (e.g., a display part or active area) may be arranged in the first wire area 712a.

For example, the second wire area 712b of the second area 1412 may be arranged on the periphery of the first wire area 712a. In the second wire area 712b, detection wires 1430, 1440, and 1450 (e.g., signal wires, conductive wires, metal wires, module crack detection (MCD) wires, circuit wires, or circuit patterns) for detecting (or sensing) a crack (e.g., damage) of the rollable display 1410 may be arranged.

According to an embodiment of the disclosure, the detection wires 1430, 1440, and 1450 arranged in the second area 1412 (e.g., a non-display area or bezel area) of the rollable display 1410 may be electrically connected (e.g., directly connected or indirectly connected) to the DDIC 720. For example, the electrical connection between the detection wires 1430, 1440 and 1450 and the DDIC 720 may refer to the description of FIG. 7B.

According to an embodiment of the disclosure, the rolling part 1410b of the rollable display 1410 may be divided into multiple areas 1460 and 1470. For example, the rolling part 1410b may include a first rolling part area 1460 and a second rolling part area 1470. The entire area of the rolling part 1410b may not be damaged, but only a portion thereof may be damaged, and in order to use the undamaged portion of the rolling part 1410b, the rolling part may be divided into a first rolling part area 1460 and a second rolling part area 1470. For example, the first rolling part area 1460 of the rolling part 1410b may be located at a lower side (e.g., at an end of the rollable display 1410), and the second rolling part area 1470 may be located at an upper side of the first rolling part area 1460. Without limitation thereto, the rolling part 1410b may be divided into three or more rolling part areas and the rollable display 1410 may be driven.

According to an embodiment of the disclosure, a first detection wire 1430 may be arranged to detect (or sense) a crack (e.g., damage) in the rolling part 1410b and the fixed part 1410a of the rollable display 4310.

According to an embodiment of the disclosure, a second detection wire 1440 may be arranged to detect (or sense) a crack (e.g., damage) in the rolling part 1410b and the fixed part 1410a of the rollable display 4310.

According to an embodiment of the disclosure, the second detection wire 1440 may be arranged to detect (or sense) a crack (e.g., damage) in the fixed part 1410a of the rollable display 4310.

According to an embodiment of the disclosure, the first detection wire 1430 and the second detection wire 1440 may be arranged to correspond to the fixed part 1410a. The first detection wire 1430 and the second detection wire 1440 may be arranged to correspond to the first area 1460 of the rolling part 1460b.

For example, the first detection wire 1430 may be arranged to correspond to a second lateral surface 14602, a lower surface (e.g., the third point 1403), and a first lateral surface 14601 of the first rolling part area 1460 of the rolling part 1410b. The first detection wire 1430 may be arranged to extend in length from the first lateral surface 14601 portion to correspond to a first lateral surface 14701 of the second rolling part area 1470 and the first lateral surface of the fixed part 1410a.

For example, the second detection wire 1440 may be arranged to correspond to a first lateral surface 14601, a lower surface (e.g., the third point 1403), and a second lateral surface 14602 of the first rolling part area 1460 of the rolling part 1410b. The second detection wire 1440 may be arranged to extend in length from the second lateral surface 14602 portion to correspond to a second lateral surface 14702 of the second rolling part area 1470 and the second lateral surface of the fixed part 1410a.

For example, the first detection wire 1430 and the second detection wire 1440 may be arranged in a portion corresponding to the first lateral surface 14601 and the second lateral surface 14602 of the first rolling part area 1460.

For example, only the first detection wire 1430 may be arranged in a portion corresponding to the first lateral surface 14701 of the second rolling part area 1470.

For example, only the second detection wire 1440 may be arranged in a portion corresponding to the second lateral surface 14702 of the second rolling part area 1470.

According to an embodiment of the disclosure, the third detection wire 1450 may be arranged to detect (or sense) a crack (e.g., damage) in the fixed part 1410a of the rollable display 1410. According to an embodiment of the disclosure, the third detection wire 1450 may be arranged to correspond to the fourth point 1404 and the fifth point 1405 of the fixed part 1410a.

According to an embodiment of the disclosure, the DDIC 720 may supply detection signals (e.g., bias voltages or sensing signals) to detect (or sense) a crack (e.g., damage) in the rollable display 1410 to a first side of each of the detection wires 1430, 1440, and 1450. The DDIC 720 may receive feedback for the detection signals (e.g., receive a bias voltage, a detection signal, a feedback voltage, a feedback signal) from a second side of each of the detection wires 1430, 1440 and 1450.

For example, the DDIC 720 may convert detection signals (e.g., bias voltages, sensing signals, feedback voltages, or feedback signals) fed back through the detection wires 1430, 1440, and 1450 into digital detection values (e.g., digital sensing values). The DDIC 720 may provide the detection values (e.g., sensing values) (e.g., signal phase values) for the detection wires 1430, 1440, and 1450 to the processor 120.

For example, the DDIC 720 may supply first detection signals (e.g., bias voltages, or sensing signals) to detect (or sense) a crack (e.g., damage) in the rollable display 1410 to the first side of the first detection wire 1430. The DDIC 720 may receive feedback for the first detection signals (e.g., receive bias voltages, detection signals, feedback voltages, or feedback signals) from the second side of the first detection wire 1430.

For example, in case that there is no crack (e.g., damage) on the first detection wire 1430, the DDIC 720 may receive feedback for the first detection signal (e.g., a bias voltage or a sensing signal).

For example, in case that a crack (e.g., damage) has occurred on the first detection wire 1430, the DDIC 720 may not receive feedback for the first detection signal (e.g., a bias voltage or a sensing signal).

According to an embodiment of the disclosure, the DDIC 720 may convert a first detection signal (e.g., a first sensing signal) fed back through the first detection wire 1430 into a first detection value (e.g., a first sensing value). The DDIC 720 may provide the first detection value (e.g., the first sensing value) (e.g., first signal phase values) for the first detection wire 1430 to the processor 120.

For example, the DDIC 720 may supply second detection signals (e.g., bias voltages, or sensing signals) to detect (or sense) a crack (e.g., damage) in the rollable display 1410 to the first side of the second detection wire 1440. The DDIC 720 may receive feedback for the second detection signals (e.g., receive bias voltages, detection signals, feedback voltages, or feedback signals) from the second side of the second detection wire 1440.

For example, if there is no crack (e.g., damage) in the second detection wire 1440, the DDIC 720 may receive feedback (e.g., receive a bias voltage, a detection signal, a feedback voltage, or a feedback signal) for the second detection signal.

For example, if a crack (e.g., damage) has occurred in the second detection wire 1440, the DDIC 720 may not receive feedback for the second detection signal.

For example, the DDIC 720 may convert the second detection signal (e.g., a bias voltage, a sensing signal, a feedback voltage, or a feedback signal) fed back through the second detection wire 1440 into a second detection value (e.g., a sensing value). The DDIC 720 may provide the second detection value (e.g., a second sensing value) (e.g., a second signal phase value) for the second detection wire 11440 to the processor 120.

For example, the DDIC 720 may supply third detection signals (e.g., bias voltages, or sensing signals) to detect (or sense) a crack (e.g., damage) in the rollable display 1410 to the first side of the third detection wire 1450. The DDIC 720 may receive feedback for the third detection signals (e.g., receive bias voltages, detection signals, feedback voltages, or feedback signals) from the second side of the third detection wire 1450.

For example, if there is no crack (e.g., damage) in the third detection wire 1450, the DDIC 720 may receive feedback (e.g., receive a bias voltage, a detection signal, a feedback voltage, or a feedback signal) for the third detection signal.

For example, if a crack (e.g., damage) has occurred in the third detection wire 1450, the DDIC 720 may not receive feedback for the third detection signal.

According to an embodiment of the disclosure, the DDIC 720 may convert a third detection signal (e.g., a third sensing signal) fed back through the third detection wire 1450 into a third detection value (e.g., a third sensing value). The DDIC 720 may provide the third detection value (e.g., a third sensing value) (e.g., a third signal phase value) for the third detection wire 1450 to the processor 120.

According to an embodiment of the disclosure, the DDIC 720 may supply the same detection signal (e.g., a bias voltage, or sensing signal) to the first detection wire 1430, the second detection wire 1440, and the third detection wire 1450.

According to an embodiment of the disclosure, the DDIC 720 may supply different detection signals (e.g., a bias voltage, or sensing signal) to the first detection wire 1430, the second detection wire 1440, and the third detection wire 1450.

For example, the processor 120 may combine and analyze the first detection value (e.g., the first sensing value or the first signal phase value), the second detection value (e.g., the second sensing value or the second signal phase value), and the third detection value (e.g., the third sensing value or the third signal phase value). Based on an analysis result of the first detection value (e.g., the first sensing value or the first signal phase value), the second detection value (e.g., the second sensing value or the second signal phase value), and the third detection value (e.g., the third sensing value or the third signal phase value), the processor 120 may determine a crack (e.g., damage) of each of the first point 1401, the second point 1402, the third point 1403 of the rolling part 1410b, and the fourth point 1404 and the fifth point 1405 of the fixed part 1410a.

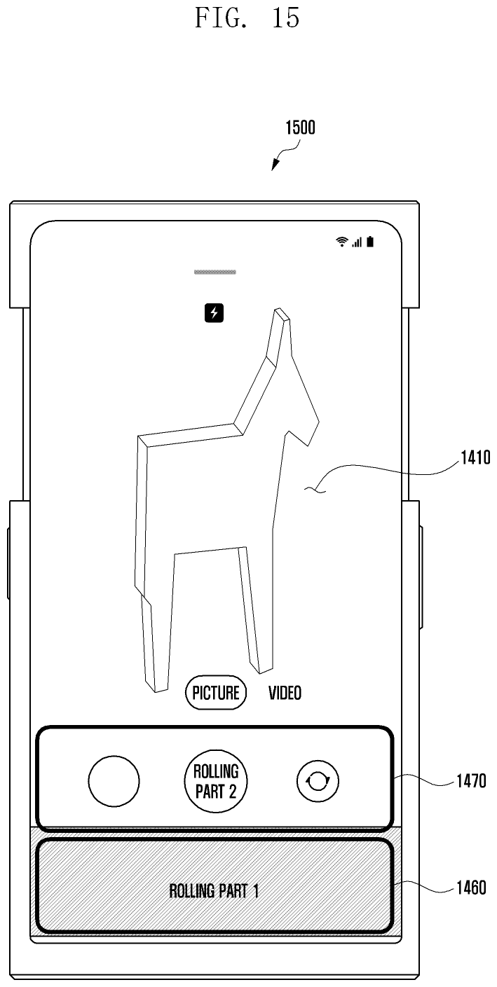

FIG. 15 is a view 1500 illustrating dividing a rolling part into multiple areas and operating the rolling part when a crack (e.g., damage) occurs in the rolling part of a rollable display according to an embodiment of the disclosure.

Referring to FIGS. 9, 14, and 15, among the first rolling part area 1460 and the second rolling part area 1470 of the rolling part 1410b, the first rolling part area 1460 may be damaged, and the second rolling part area 1470 may not be damaged.

According to an embodiment of the disclosure, the processor 120 may determine whether a crack (e.g., damage) has occurred in each of the first rolling part area 1460, the second rolling part area 1470 of the rolling part 1410b, and the fixed part 1410a by combining and analyzing the first detection value (e.g., the first sensing value or the first signal phase value) of the first detection wire 1430, the second detection value (e.g., the second sensing value or the second signal phase value) of the second detection wire 1440, and the third detection value (e.g., the third sensing value or the third signal phase value) of the third detection wire 1450.

For example, the processor 120 may combine and analyze of the first detection value (e.g., the first sensing value or the first signal phase value) of the first detection wire 1430 and the second detection value (e.g., the second sensing value or the second signal phase value) of the second detection wire 1440 to determine whether a crack (e.g., damage) has occurred at each of the first point 1401 of the rolling part 1410b (e.g., a first side of the rolling part 1410b), the second point 1402 of the rolling part 1410b (e.g., a second side of the rolling part 1410b), and the third point 1403 of the rolling part 1410b.

According to an embodiment of the disclosure, the processor 120 may determine whether a crack (e.g., damage) has occurred in each of the fourth point 1404 of the fixed part 1410a by combining and analyzing the first detection value (e.g., the first sensing value or the first signal phase value) of the first detection wire 1430 and the third detection value (e.g., third sensing value or the third signal phase value) of the third detection wire 1450.

According to an embodiment of the disclosure, the processor 120 may determine whether a crack (e.g., damage) has occurred in each of the fifth point 1405 of the fixed part 1410a by combining and analyzing the second detection value (e.g., the second sensing value or the second signal phase value) of the second detection wire 1440 and the third detection value (e.g., third sensing value or the third signal phase value) of the third detection wire 1450.

For example, in case that a crack (e.g., damage) has occurred at the first point 1401, the third detection value (e.g., the third sensing value or the third signal phase value) of the third detection wire 1450 is received normally, and at least one of the first detection value (e.g., the first sensing value or the first signal phase value) of the first detection wire 1430 and the second detection value (e.g., the second sensing value or the second signal phase value) of the second detection wire 1440 may be abnormal.

For example, in case that a crack (e.g., damage) has occurred at the second point 1402, the third detection value (e.g., the third sensing value or the third signal phase value) of the third detection wire 1450 is received normally, and at least one of the first detection value (e.g., the first sensing value or the first signal phase value) of the first detection wire 1430 and the second detection value (e.g., the second sensing value or the second signal phase value) of the second detection wire 1440 may be abnormal.

For example, in case that a crack (e.g., damage) has occurred at the third point 1403, the third detection value (e.g., the third sensing value or the third signal phase value) of the third detection wire 1450 is received normally, and both the first detection value (e.g., the first sensing value or the first signal phase value) of the first detection wire 1430 and the second detection value (e.g., the second sensing value or the second signal phase value) of the second detection wire 1440 may be abnormal.

For example, in case that a crack (e.g., damage) has occurred at the fourth point 1404, the second detection value (e.g., the second sensing value or the second signal phase value) of the second detection wire 1440 is received normally, and at least one of the first detection value (e.g., the first sensing value or the first signal phase value) of the first detection wire 1430 and the third detection value (e.g., the third sensing value or the third signal phase value) of the third detection wire 1450 may be abnormal.

For example, in case that a crack (e.g., damage) has occurred at the fifth point 1405, the first detection value (e.g., the first sensing value or the first signal phase value) of the first detection wire 1430 is received normally, and at least one of the second detection value (e.g., the second sensing value or the second signal phase value) of the second detection wire 1440 and the third detection value (e.g., the third sensing value or the third signal phase value) of the third detection wire 1450 may be abnormal.

As such, the processor 120 may determine whether there is a crack (e.g., damage) in each of the fixed part 1410a and the rolling part 1410b by combining and analyzing the first detection value of the first detection wire 1430, the second detection value of the second detection wire 1440, and the third detection value of the third detection wire 1450.

For example, if it is determined that there is no crack (e.g., damage) in the fixed part 1410a, the processor 120 may control the fixed part 1410a to enable screen use.

For example, in case that a crack (e.g., damage) has occurred in the first rolling part area 1460 of the rolling part 1410b and no crack (e.g., damage) has occurred in the second rolling part area 1470, the processor 120 may control the first rolling part area 1460 of the rolling part 1410b to display a black screen (e.g., so that the screen is not displayed). The processor 120 may control the second rolling part area 1470 of the rolling part 1410b to display a screen normally.

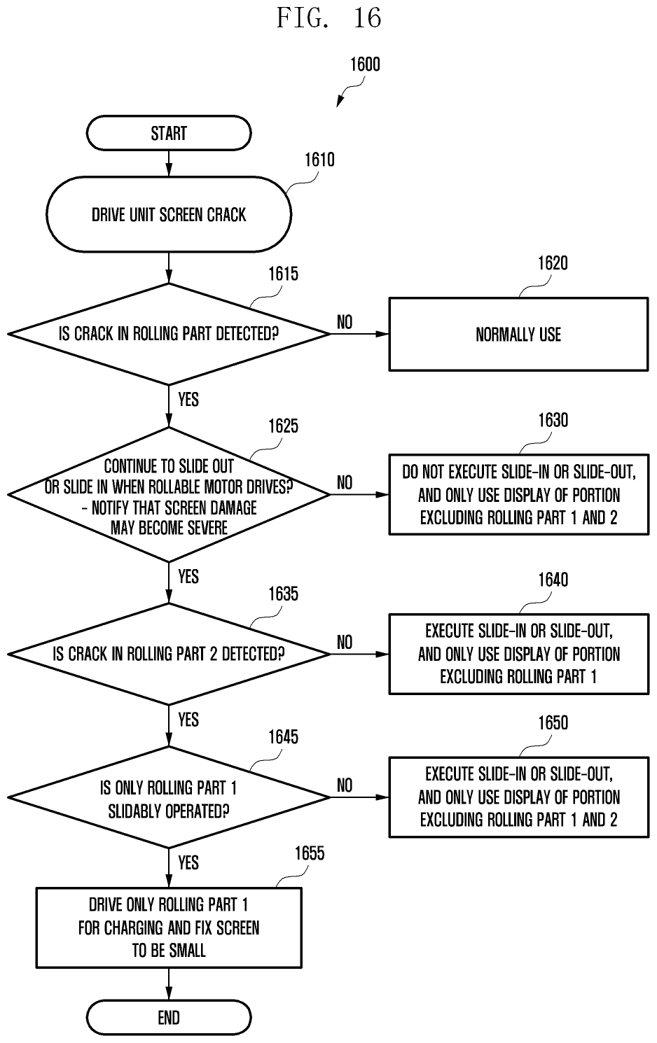

FIG. 16 is a flowchart 1600 illustrating a method for dividing a rolling part into multiple areas and operating the rolling part when a crack (e.g., damage) occurs in the rolling part of a rollable display according to an embodiment of the disclosure.

Referring to FIGS. 9, 14, 15, and 16, in operation 1610, the processor 120 may perform a crack (e.g., damage) detection operation for the rollable display 1410.

In operation 1615, the processor 120 may determine whether a crack (e.g., damage) in the rolling part of the rollable display 1410 is detected.

As a result of the determination in operation 1615, in case that a crack (e.g., damage) in the rolling part of the rollable display 1410 is not detected, the processor 120 may perform operation 1620.

In operation 1620, the processor 120 may control the rollable display 1410 to be used normally.

As a result of the determination in operation 1615, in case that a crack (e.g., damage) in the rolling part 1410b of the rollable display 1410 is detected, the processor 120 may perform operation 1625.

In operation 1625, the processor 120 may determine whether to slide out or slide in the rollable display 1410 by driving the motor 780.

For example, the processor 120 may display a menu on the screen for selecting whether to slide the rollable display 1410 in/out, and drive the motor 780 based on the menu selection. In addition, the processor 120 may display a phrase (or graphic object) on the screen regarding the detection of a crack in the rolling part 1410b of the rollable display 1410. The processor 120 may display a warning message (or output a warning voice notification) indicating that the sliding in/out of the rollable display 710 may make the screen damage severe when the motor 780 is driven.

If the motor 780 is not driven by the user's choice, the processor 120 may perform operation 1630.

If the motor 780 is driven by the user's choice, the processor 120 may perform operation 1635.

In operation 1630, the processor 120 may control the driving of the DDIC 720 and the rollable display 1410 so that the fixed part 1410a in which no crack (e.g., damage) has occurred may be used, excluding the rolling part 1410b in which a crack (e.g., damage) has occurred.

In operation 1635, the processor 120 may determine whether a crack (e.g., damage) has occurred in the second rolling part area 1470.

As a result of the determination in operation 1635, in case that it is determined that a crack (e.g., damage) has not occurred in the second rolling part area 1470, operation 1640 may be performed.

In operation 1640, the processor 120 may drive the motor 780 so that the sliding out or sliding in of the rollable display 1410 may be executed. In addition, the processor 120 may control the driving of the DDIC 720 and the rollable display 1410 so that the screen of the second rolling part area 1470 excluding the first rolling part area 1460 of the rolling part 1410b and the fixed part 1410a may be used.

As a result of the determination in operation 1635, in case that it is determined that a crack (e.g., damage) has occurred in the second rolling part area 1470, operation 1645 may be performed.

In operation 1645, the processor 120 may determine whether to execute the sliding out or sliding in only the first rolling part area 1460 among the first rolling part area 1460 and the second rolling part area 1470 of the rolling part 1410b.

As a result of the determination in operation 1645, in case that it is determined not to execute the sliding out or sliding in of the first rolling part area 1460, the processor 120 may perform operation 1650.

In operation 1650, the processor 120 may control the driving of the DDIC 720 and the rollable display 1410 so that the screen of the fixed part 1410a excluding the first rolling part area 1460 and the second rolling part area 1470 of the rolling part 1410b may be used.

As a result of the determination in operation 1645, in case that it is determined to execute the sliding out or sliding in of the first rolling part area 1460, operation 1655 may be performed.

In operation 1655, the processor 120 may control the driving of the DDIC 720 and the rollable display 1410 so that the screen of the fixed part 1410a and the screen of the first rolling part area 1460 among the first rolling part area 1460 and the second rolling part area 1470 of the rolling part 1410b may be used for charging the electronic device 1400. In addition, the processor 120 may fix a screen size of the rollable display 1410 to be small so that the second rolling part area 1470 is not visually exposed to the outside.

An electronic device 700 according to an embodiment of the disclosure may include a housing (e.g., the first housing 210 or the second housing 220 in FIG. 2A), a display (e.g., the rollable display 710 in FIG. 7A) including a fixed part (e.g., the fixed part 710a in FIG. 7A) which maintains a substantially flat surface and a rolling part (e.g., the rolling part 710b in FIG. 7A) extending from the fixed part 710a and having a portion bent according to movement so as to be partially slid out from the housing or slid into the housing, a display driver integrated circuit (IC) (e.g., the DDIC 720 in FIG. 7A) configured to drive the display 710, and a processor (e.g., the processor 120 in FIG. 7A) configured to control the display driver IC 720.

The display 710 may include multiple detection wires (e.g., the first detection wire 730, the second detection wire 740, and the third detection wire 750 in FIG. 7A) connected to the display driver IC 720 to distinguish and detect damage of the fixed part 710a or the rolling part 710b and arranged on an edge of the display 710.

According to an embodiment of the disclosure, the electronic device 700 may control the display driver IC 720 to provide detection signals for detecting damage of the display 710 to first sides (e.g., 731, 741, and 751 in FIG. 7B) of the respective multiple detection wires 730, 740, and 750. The electronic device 700 may receive feedback signals for the detection signals input from second sides (e.g., 732, 742, and 752 in FIG. 7B) of the respective multiple detection wires 730, 740, and 750 through the display driver IC 720. The electronic device 700 may determine whether the fixed part 710a or the rolling part 710b is damaged based on the feedback signals.

For example, the electronic device 700 may determine whether the fixed part 710a and the rolling part 710b are damaged based on the feedback signals for the detection signals input from second sides (e.g., 732, 742, and 752 in FIG. 7B) of the respective multiple detection wires 730, 740, and 750 through the display driver IC 720.

For example, the electronic device 700 may determine whether at least one of the fixed part 710a and the rolling part 710b is damaged based on the feedback signals for the detection signals input from second sides (e.g., 732, 742, and 752 in FIG. 7B) of the respective multiple detection wires 730, 740, and 750 through the display driver IC 720.

According to an embodiment of the disclosure, the electronic device 700 may control the display driver IC 720 to convert the feedback signals into detection values corresponding to the respective multiple detection wires 730, 740, and 750. The electronic device 700 may compare the detection values with pre-stored values to determine whether the fixed part 710a or the rolling part 710b is damaged.

For example, the electronic device 700 may compare the detection values with pre-stored values to determine whether the fixed part 710a and the rolling part 710b are damaged.

For example, the electronic device 700 may compare the detection values with pre-stored values to determine whether at least one of the fixed part 710a and the rolling part 710b is damaged.

According to an embodiment of the disclosure, the electronic device 700 may compare phases of the detection signals with phases of the feedback signals. The electronic device 700 may determine damage of the fixed part 710a or the rolling part 710b, based on phase changes of the feedback signals relative to phases of the detection signals.

For example, the electronic device 700 may determine damage of the fixed part 710a and the rolling part 710b, based on phase changes of the feedback signals relative to phases of the detection signals.

For example, the electronic device 700 may determine damage of at least one of the fixed part 710a and the rolling part 710b, based on phase changes of the feedback signals relative to phases of the detection signals.

According to an embodiment of the disclosure, the multiple detection wires 730, 740, and 750 may include a first detection wire 730 and a second detection wire 740 arranged to detect damage of the rolling part 710b. The first detection wire 730 may include a first part arranged to correspond to the rolling part 710b and a second part arranged to extend in length from the first part so as to correspond to a first area of the fixed part 710a. The second detection wire 740 may include a third part arranged to correspond to the rolling part 710b and a fourth part arranged to extend in length from the third part so as to correspond to a second area of the fixed part 710a.

According to an embodiment of the disclosure, among the multiple detection wires 730, 740, and 750, a wire arranged outside the edge of the display 710 has a line width greater than that of a wire arranged relatively inside.

For example, among the multiple detection wires 730, 740, and 750, a wire arranged relatively outside the edge of the display 710 has a line width greater than that of a wire arranged relatively inside.

According to an embodiment of the disclosure, the multiple detection wires 730, 740, and 750 may include a third detection wire 750 arranged to correspond to the first area of the fixed part 710a and the second area of the fixed part so as to detect damage of the fixed part 710a.

According to an embodiment of the disclosure, the electronic device 700 may determine whether at least one of the first area of the fixed part 710a, the second area of the fixed part 710a, and the rolling part 710b is damaged, based on a first feedback signal input from the first detection wire 730 and a third feedback signal input from the third detection wire 750.

According to an embodiment of the disclosure, the electronic device 700 may determine whether at least one of the first area of the fixed part 710a, the second area of the fixed part 710a, and the rolling part 710b is damaged, based on a second feedback signal input from the second detection wire 740 and the third feedback signal input from the third detection wire 750.

According to an embodiment of the disclosure, in case that the rolling part 710b is determined to have been damaged, the electronic device 700 may control the display driver IC 720 to stop screen display driving of the rolling part 710b and display a message informing the damage of the rolling part 710b on the fixed part 710a.

According to an embodiment of the disclosure, in case that the rolling part 710b is determined to have been damaged, the electronic device 700 may control the display driver IC 720 to cause the display 710 to maintain a screen ratio of a slide-in state even in a slide-out state of the electronic device 700.

With respect to an operating method of an electronic device according to an embodiment of the disclosure, the electronic device 700 may include a housing 210 or 220, a display 710 including a fixed part 710a which maintains a substantially flat surface and a rolling part 710b extending from the fixed part 710a and having a portion bent according to movement so as to be partially slid out from the housing or slid into the housing, a display driver integrated circuit (IC) 720 configured to drive the display 710, and a processor 120 configured to control the display driver IC 720. The display 710 may include multiple detection wires 730, 740, and 750 connected to the display driver IC 720 to distinguish and detect damage of the fixed part 710a or the rolling part B and arranged on an edge of the display 710. The operating method may include driving the display driver IC 720 so that detection signals for detecting damage of the display 710 are supplied to a first side of each of the multiple detection wires 730, 740, and 750. The operating method may include determining whether the fixed part 710a or the rolling part 710b is damaged based on the feedback signals for the detection signals input from second sides of the respective multiple detection wires 730, 740, and 750 through the display driver IC 720.

For example, the operating method may include determining whether the fixed part 710a and the rolling part 710b are damaged based on the feedback signals for the detection signals input from second sides of the respective multiple detection wires 730, 740, and 750 through the display driver IC 720.

For example, the operating method may include determining whether at least one of the fixed part 710a and the rolling part 710b is damaged based on the feedback signals for the detection signals input from second sides of the respective multiple detection wires 730, 740, and 750 through the display driver IC 720.

According to an embodiment of the disclosure, in the operating method, the electronic device 700 may control the display driver IC 720 to convert the feedback signals into detection values corresponding to the respective multiple detection wires 730, 740, and 750. The operating method may include comparing the detection values with pre-stored values to determine whether the fixed part 710a or the rolling part 710b is damaged.

For example, the operating method may include comparing the detection values with pre-stored values to determine whether the fixed part 710a and the rolling part 710b are damaged.

For example, the operating method may include comparing the detection values with pre-stored values to determine whether at least one of the fixed part 710a and the rolling part 710b is damaged.

According to an embodiment of the disclosure, in the operating method, the electronic device 700 may compare phases of the detection signals with phases of the feedback signals. The operating method may include determining damage of the fixed part 710a or the rolling part 710b, based on phase changes of the feedback signals relative to phases of the detection signals.

For example, the operating method may include determining damage of the fixed part 710a and the rolling part 710b, based on phase changes of the feedback signals relative to phases of the detection signals.

For example, the operating method may include determining damage of at least one of the fixed part 710a and the rolling part 710b, based on phase changes of the feedback signals relative to phases of the detection signals.

According to an embodiment of the disclosure, the multiple detection wires 730, 740, and 750 may include a first detection wire 730 and a second detection wire 740. The first detection wire 730 may include a first part arranged to correspond to the rolling part 710b and a second part arranged to extend in length from the first part so as to correspond to a first area of the fixed part 710a. The second detection wire 740 may include a third part arranged to correspond to the rolling part 710b and a fourth part arranged to extend in length from the third part so as to correspond to a second area of the fixed part 710a. The operating method may include determining damage of the rolling part 710b based on feedback signals input from the first detection wire 730 and the second detection wire 740.

According to an embodiment of the disclosure, the multiple detection wires 730, 740, and 750 may include a third detection wire 750 arranged to correspond to the first area of the fixed part 710a and the second area of the fixed part. The operating method may include determining damage of the fixed part 710a based on a feedback signal input from the third detection wire 750.

According to an embodiment of the disclosure, the electronic device 700 may determine whether at least one of the first area of the fixed part 710a, the second area of the fixed part 710a, and the rolling part 710b is damaged, based on a first feedback signal input from the first detection wire 730 and a third feedback signal input from the third detection wire 750.

According to an embodiment of the disclosure, the electronic device 700 may determine whether at least one of the first area of the fixed part 710a, the second area of the fixed part 710a, and the rolling part 710b is damaged, based on a second feedback signal input from the second detection wire 740 and the third feedback signal input from the third detection wire 750.

According to an embodiment of the disclosure, in case that the rolling part 710b is determined to have been damaged, the electronic device 700 may control the display driver IC 720. The electronic device may stop screen display driving of the rolling part 710b and display a message informing the damage of the rolling part 710b on the fixed part 710a.

According to an embodiment of the disclosure, in case that the rolling part 710b is determined to have been damaged, the electronic device 700 may control the display driver IC 720 to cause the display 710 to maintain a screen ratio of a slide-in state even in a slide-out state of the electronic device 700.

The rollable electronic device and the operating method thereof according to various embodiments of the disclosure may detect a crack (e.g., damage) in each of a fixed part and a rolling part of the rollable display.

The rollable electronic device and the operating method thereof according to various embodiments of the disclosure may segment the rolling part of the rollable display into multiple areas and detect a crack (e.g., damage) in each of the multiple areas of the rolling part of the rollable display.

The rollable electronic device and the operating method thereof according to various embodiments of the disclosure may detect a crack (e.g., damage) in the rolling part of the rollable display and control the operation of the rollable display.

The rollable electronic device and the operating method thereof according to various embodiments of the disclosure may maintain a screen ratio of a pushed-in (e.g., slide-in) state even in a pulled-out (e.g., slide-out) state when a crack (e.g., damage) occurs in the rolling part of the rollable display.

The rollable electronic device and the operating method thereof according to various embodiments of the disclosure may detect a crack (e.g., damage) in the rolling part of the rollable display and control driving of a motor for pushing in and pulling out the rollable display.

The rollable electronic device and the operating method thereof according to various embodiments of the disclosure may display a notification message (or provide a voice comment on the occurrence of a crack (or damage) in the rolling part of the rollable display) when a crack occurs (e.g., damage).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
a display comprising a fixed part maintaining a substantially flat surface and a rolling part extending from the fixed part and having a portion bent according to movement so as to be partially slid out from the housing or slid into the housing;
a display driver integrated circuit (IC) configured to drive the display;
memory, comprising one or more storage media, storing instructions; and
at least one processor, configured to control the display driver IC, communicatively coupled to the display, the display driver IC, and the memory,
wherein the display comprises multiple detection wires connected to the display driver IC to distinguish and detect damage of the fixed part or the rolling part and arranged on an edge of the display.

2. The electronic device of claim 1, wherein the instructions, when executed by the at least one processor individually or collectively, cause the electronic device to:
control the display driver IC to provide detection signals for detecting damage of the display to first sides of the respective multiple detection wires, and
determine whether at least one of the fixed part or the rolling part is damaged, based on feedback signals for the detection signals, which are input from second sides of the respective multiple detection wires through the display driver IC.

3. The electronic device of claim 2, wherein the instructions, when executed by the at least one processor individually or collectively, further cause the electronic device to:
control the display driver IC to convert the feedback signals into detection values corresponding to the respective multiple detection wires, and
compare the detection values with prestored values to determine whether at least one of the fixed part or the rolling part is damaged.

4. The electronic device of claim 2, wherein the instructions, when executed by the at least one processor individually or collectively, further cause the electronic device to:
compare phases of the detection signals with phases of the feedback signals, and
determine whether at least one of the fixed part or the rolling part is damaged, based on phase changes of the feedback signals relative to the phases of the detection signals.

5. The electronic device of claim 1,
wherein the multiple detection wires comprise a first detection wire and a second detection wire arranged to detect damage of the rolling part,
wherein the first detection wire comprises a first part arranged to correspond to the rolling part and a second part arranged to extend in length from the first part so as to correspond to a first area of the fixed part, and
wherein the second detection wire comprises a third part arranged to correspond to the rolling part and a fourth part arranged to extend in length from the third part so as to correspond to a second area of the fixed part.

6. The electronic device of claim 1, wherein among the multiple detection wires, a wire arranged relatively outside the edge of the display has a line width greater than that of a wire arranged relatively inside.

7. The electronic device of claim 5, wherein the multiple detection wires comprise a third detection wire arranged to correspond to the first area of the fixed part and the second area of the fixed part to detect damage of the fixed part.

8. The electronic device of claim 7, wherein the instructions, when executed by the at least one processor individually or collectively, cause the electronic device to determine whether at least one of the first area of the fixed part, the second area of the fixed part, and the rolling part is damaged, based on a first feedback signal input from the first detection wire and a third feedback signal input from the third detection wire.

9. The electronic device of claim 8, wherein the instructions, when executed by the at least one processor individually or collectively, cause the electronic device to determine whether at least one of the first area of the fixed part, the second area of the fixed part, and the rolling part is damaged, based on a second feedback signal input from the second detection wire and the third feedback signal input from the third detection wire.

10. The electronic device of claim 1, wherein the instructions, when executed by the at least one processor individually or collectively, cause the electronic device to, in case that the rolling part is determined to have been damaged, control the display driver IC to stop screen display driving of the rolling part and display a message informing the damage of the rolling part on the fixed part.

11. The electronic device of claim 1, wherein the instructions, when executed by the at least one processor individually or collectively, cause the electronic device to, in case that the rolling part is determined to have been damaged, control the display driver IC to cause the display to maintain a screen ratio of a slide-in state even in a slide-out state of the electronic device.

12. A method of operating an electronic device,
wherein the electronic device includes a housing, a display comprising a fixed part maintaining a flat surface and a rolling part extending from the fixed part and having a portion bent according to movement so as to be partially slid out from the housing or slid into the housing, a display driver integrated circuit (IC) configured to drive the display, memory, including one or more storage media, storing instructions, and at least one processor, configured to control the display driver IC, communicatively coupled to the display, the display driver IC, and the memory, wherein the display includes multiple detection wires connected to the display driver IC to distinguish and detect damage of the fixed part or the rolling part, and arranged on an edge of the display, and
wherein the method comprises:
driving the display driver IC so that detection signals for detecting damage of the display are supplied to first sides of the respective multiple detection wires,
receiving feedback signals for the detection signals input from second sides of the respective multiple detection wires through the display driver IC, and
determining whether at least one of the fixed part or the rolling part is damaged, based on the feedback signals.

13. The method of claim 12, further comprising:
controlling the display driver IC to convert the feedback signals into detection values corresponding to the respective multiple detection wires; and
comparing the detection values with prestored values to determine whether at least one of the fixed part or the rolling part is damaged.

14. The method of claim 12, further comprising:
comparing phases of the detection signals with phases of the feedback signals; and
determining whether at least one of the fixed part or the rolling part is damaged, based on phase changes of the feedback signals relative to the phases of the detection signals.

15. The method of claim 12,
wherein the multiple detection wires comprise a first detection wire and a second detection wire,
wherein the first detection wire comprises a first part arranged to correspond to the rolling part and a second part arranged to extend in length from the first part so as to correspond to a first area of the fixed part,
wherein the second detection wire comprises a third part arranged to correspond to the rolling part and a fourth part arranged to extend in length from the third part so as to correspond to a second area of the fixed part, and
wherein the method further comprises determining damage of the rolling part based on feedback signals input from the first detection wire and the second detection wire.

16. The method of claim 15,
wherein the multiple detection wires comprise a third detection wire arranged to correspond to the first area of the fixed part and the second area of the fixed part, and
wherein the method further comprising:
determining damage of the fixed part based on a feedback signal input from the third detection wire.

17. The method of claim 16, further comprising:
determining whether at least one of the first area of the fixed part, the second area of the fixed part, and the rolling part is damaged, based on a first feedback signal input from the first detection wire and a third feedback signal input from the third detection wire.

18. The method of claim 16, further comprising:
determining whether at least one of the first area of the fixed part, the second area of the fixed part, and the rolling part is damaged, based on a second feedback signal input from the second detection wire and the third feedback signal input from the third detection wire.

19. The method of claim 12, further comprising:
wherein in case that damage of the rolling part is determined, controlling the display driver IC to stop screen display driving of the rolling part and displaying a message informing the damage of the rolling part on the fixed part.

20. The method of claim 12, further comprising:
wherein in case that damage of the rolling part is determined, controlling the display driver IC to cause the display to maintain a screen ratio of a slide-in state even in a slide-out state of the electronic device.
